(19) United States
(12) Patent Application Publication
(10) Pub. No.: US 2013/0314749 A1
(43) Pub. Date: Nov. 28, 2013

(54) SYSTEM AND METHOD FOR THE CREATION OF AN E-ENHANCED MULTI-DIMENSIONAL PICTOKIDS PRESENTATION USING PICTOOVERLAY TECHNOLOGY

(71) Applicant: Ian A. R. Boyd, North Las Vegas, NV (US)

(72) Inventor: Ian A. R. Boyd, North Las Vegas, NV (US)

(21) Appl. No.: 13/830,513

(22) Filed: Mar. 14, 2013

Related U.S. Application Data
(60) Provisional application No. 61/652,306, filed on May 28, 2012.
(60) Provisional application No. 61/705,686, filed on Sep. 26, 2012.
(60) Provisional application No. 61/716,508, filed on Oct. 20, 2012.
(60) Provisional application No. 61/750,022, filed on Jan. 8, 2013.
(60) Provisional application No. 61/763,749, filed on Feb. 12, 2013.

(51) Int. Cl. G06T 11/60; G06K 15/02

(52) U.S. Cl. CPC G06T 11/60; G06K 15/1848
USPC 358/1.18; 382/284

(57) ABSTRACT

A software application program on a computer platform allows a user to create a presentation from a series of image selections that are developed into sequenced PictoStorys that transform a structured basic idea into a pictorial interpretation in the form of an E-Enhanced Multi-Dimensional PictoKids Adventure Presentation. The software application program develops a storyline and structures an Architectural Blueprint into a series of Scenes and Part Scenes that create placeholders for the User's image selections. The PictoStorys are created from a stylized process using PictoOverlay Technology that creates and layers transparent static images and displays them dynamically and sequentially, adding audio and video enhancements to create a User designed film-like presentation. The software program further provides the capability to print the static images on paper or transparent sheets to intrigue, entertain, educate, and have users interact with the PictoKids Adventure.

### CROSS REFERENCE TO RELATED APPLICATIONS

This application claims the benefit of U.S. Provisional Application No. 61/652,306 filed May 28, 2012 entitled AUDIO VIDEO FILM CREATOR FROM STORYLINE, CAST AND CONTEXT SETTINGS INPUT, U.S. Provisional Application No. 61/705,686 filed Sep. 26, 2012 entitled SYSTEM AND METHOD FOR THE CREATION OF ENHANCED AUDIO VISUAL STORYBOARDS USING A LAYERED COMPOSITE IMAGE GENERATOR, U.S. Provisional Application No. 61/716,508 filed Oct. 20, 2012 entitled SYSTEM AND METHOD FOR THE CREATION OF AN ENHANCED MULTI-DIMENSIONAL PICTOGAME, U.S. Provisional Application No. 61/750,022 filed Jan. 8, 2013 entitled SYSTEM AND METHOD FOR THE CREATION OF AN E-ENHANCED MULTI-DIMENSIONAL PICTOKIDS PRESENTATION and U.S. Provisional Application No. 61/763,749 filed Feb. 12, 2013 PAYMENT AND ACCOUNT MANAGEMENT SYSTEM USING PICTOOVERLAY TECHNOLOGY which are hereby incorporated herein by reference in their entireties.

### FIELD OF INVENTION

The present invention relates to a software application system and method for the creation of adventure stories using PictoOverlay Technology that are dynamically presented in an enhanced featured, displayable, narrated, and musicked, Multi-Dimensional presentation.

The PictoKids Application Software performs a threefold transformation wherein a first step is the transformation of a chosen Theme into a structured storyline and blank Blueprint. In a second step the PictoKids Application Software transforms the blank Blueprint into a pictorially populated Architectural Blueprint through a User's selection of images from montages that are presented and that reflect answers to key concept queries, applied to each component of the storyline structure; the Who, What, Where When . . . etc. In a third step the PictoKids Application Software transforms, sequences, extracts and enhances the pictorial User input selections to create a dynamic PictoKids Adventure Presentation using the Pictorial Overlay Technology.

These three transformations . . . reduce an infinite number of PictoKids Adventure images to practical and manageable selection options, available and resident on the user device. The PictoKids Adventure Presentation is presented using the Pictorial Overlay Interface based on Pictorial Montages to guide, prompt, explain, print and display the Presentation.

In creating the Presentation, the PictoKids Application Software includes a Storyline Generator that structures the adventure into Scenes and Part Scenes based on a chosen Theme and Theme Sub-Topic. This structure is used to format a unique Architectural Blueprint that is used as the workspace to develop the PictoKids Adventure Presentation. Using this blank structured Blueprint, the Scenes and Part Scenes are further expanded by applying Key Concept Queries for the who, what, where and the actions and outcomes that take place within each Scene. The PictoKids Software then prompts and leads the User to populate this blank Blueprint structure by allowing for a User to select images . . . one by one for each scene and part scene, from a series of pictorial image montages that the software presents based on the structure and chosen Major Theme and Theme Sub-Topic.

This structure of the Scenes and Part Scenes transforms the Theme chosen for PictoKids Adventure story into a series of sequenced PictoStorys using the PictoStory Technology described in U.S. Provisional Application No. 61/705,686 which is incorporated herein by reference. The PictoStorys are organized into the Scenes and Part Scenes structured by the Storyline Generator within the populated Architectural Blueprint and dynamic Enhancements are associated with the PictoStorys to create the PictoKids Adventure Presentation based on the User chosen Major Theme and Theme Sub-Topic.

To ensure clarity of this invention, it is important to distinguish between “choosing” a theme, and “selecting” an image that pertains to and populates the generated structure of the Scenes and Part Scenes of the PictoKids Adventure. Both processes serve and intend to narrow the number of selectable pictorial images available to a User. The words chose and select are specifically and carefully used to denote specific meanings in this application . . . choose a theme . . . or select an image.

Within the Pictorial Architectural Blueprint, the PictoKids Application Software employs a top down approach to expand and extend the chosen Theme Topic into a scene structure with textual Key Concept queries applied to each scene/part-scene that allow the user to transform the blank structure into a pictorially populated structure by selecting images provided by the software at each level. This user selection process and pictorially populated structure allows the software internally to create either PictoLayers such as a Trans-Snip or Composite Image required to be used in or to create a dynamic PictoStory. These PictoStorys are then further enhanced using various media formats, such as, Narration, Music, Sound Effects, Video Effects, Animation, and other supportive elements to dynamically transform the PictoStorys into the Multi-Dimensional PictoKids Adventure Presentation. Any Image and/or PictoLayer may be selected by a User and printed on paper, transparent sheets, postage sheets, sticker labels, or fabrics and other materials to provide for the User to create and manufacture vibrant displays. The Collage/Pastiche Images of the features and characters of the PictoKids Adventure may also be pre-formed label cut outs or be adhered to a fabric fastener such as Velcro which may then be placed on a Display Board lines with the fabric fastener that may include digital sound to narrate or complement the PictoKids Adventure images. Access and operation of the PictoKids Software may be controlled using the unique PictoIdentity features of the PictoGame Technology described in U.S. Provisional Application No. 61/716,508 and of the PictoCash Technology described in 61/763,749 which are each incorporated herein by reference.

### BACKGROUND OF THE INVENTION

Stories may commonly be told using current software applications by typing the text and dialog of the story and adding pictures or drawings to better convey character details, scenes and actions of the story. The text may be printed in a book or report format, and the pictures may be printed and displayed. More sophisticated methods may present the story as a film or play with the textual dialog serving as the script and constructed scenery or outdoor locations serving as the backdrop of the feature. These methods present complexities that may make it difficult for a child to take part in the development and execution of the creative process.

These processes also render one realization of the story the result of which is invariably one-off, final and finite. To change or adapt a scene or outcome, dialog must be rewritten, typed and printed and be acted again as a new scene within the film or play. Additionally, once a typed page or picture is printed there are limited activities that may be performed to enhance or further create and adapt a story to new creative ideas to change an outcome or resolve a conflict within the context of the plot of the story. No software is available that transforms the story into a presentable multi-functional, Multi-Dimensional film-like narrated, musicked adventure that may be instantly changeable with variable Components that may be printed and creatively arranged in numerous formats.

### BRIEF SUMMARY OF THE INVENTION

The PictoKids Application Software performs a threefold transformation process of generating a storyline, populating a blank Architectural Blueprint and providing to a User the Pictorial Overlay Interface (POI) to view and print the PictoKids Adventure Presentation. This transformation process includes the steps of (1) A User Choosing a Major Theme; (2) Structuring a storyline and formatting a Blank Architectural Blue Print based on the chosen Major Theme and storyline; (3) Structuring Scenes, Part Scenes and PictoStories from the storyline and populating the Architectural Blueprint with images selected by the User through prompts directed to the storyline. The software transforms, sequences, extracts and enhances User selected images to create the PictoKids Adventure Presentation.

Through this three part transformation process the PictoKids Software Application system and method transforms a Major Theme and Theme Sub-Topic chosen by a User into an artistic, informative, educational, and/or factual story or adventure feature that through enhancements becomes a displayable narrated, musicked, audio, video, multi-dimensional presentation. The PictoKids Application Software system structures a blank Architectural Blue Print into Scenes and Part Scenes of a PictoKids Adventure Story and prompts the User to populate each Scene and Part Scene by selecting images that the Software then transforms into PictoLayers used to develop and sequence a series of PictoStorys used in the PictoKids Adventure Presentation.

Access to the PictoKids Application Software is provided through a procurement transaction using a transfer code that generates an amount of time or number of points (i.e. PictoCash) that is depleted by using the software for a period of time or at the completion of the PictoKids Adventure Presentation. The transfer code is obtained through a retail purchase and is validated by completing a PictoIdentity and the amount of available time or points are then tracked in a PictoCash Account. Access is halted or denied if an insufficient amount of time, points or PictoCash is available for the User to continue to use the PictoKids Application Software.

Importantly, within the Data Store Resource of the PictoKids Application Software there are millions of pictures that may represent an infinite variety of Themes. The PictoKids Software therefore restricts and limits the presentation of these pictorial images by thematically grouping the images into a series of Image Selector Montage Pages. The display of these Image Selector Montage Pages is in a 3×3 matrix that are easily reviewed and that greatly decreases the amount of time needed by a User to choose a Theme and select the images that conform to the Scenes and Part Scenes and that will be developed into PictoLayers to be used in the PictoStory. Instead through the chosen Theme Topic and application of a KeyConcepts Query to the structured Scenes and Part Scenes using the Storyline Generator, an infinite number of images is narrowed to a limited number of selections for the User. Also importantly, from this grouping and reduction in the variety of available images, the server does not need to download millions of pictures improving access and download speeds.

The sequence of PictoStorys may be ordered into Acts, Scenes and Part Scenes and a Prologue and Epilogue may be added that provide for a User to include a special message and email the presentation to a loved one such as a teacher, parent, grandparent, sibling, etc. The presentation may further be entered and reviewed competitively through an online connection to receive a reward or more operational time or points (i.e. PictoCash Points). The system and method further provides the ability to print any element of the PictoKids Adventure story and place them on an audio/video Display Board to develop artistic creations to amuse, entertain and show the creative talents of the User. The printing capability is dependent on the underlying transformation of the storyline of the PictoKids Adventure. Printing may be on paper, or paper adhered to a fabric fastener such as Velcro, or on transparencies, or pre-cut Avery labels that are specifically shaped for characters and things in the PictoKids Presentation, people shapes, car shapes, spaceship shapes, animal shapes, etc. with the printout being mapped to match the fabric fastener such as Velcro paper, transparency or label shape. The cutouts may be used in conjunction with a Display Board that may have digital sound that provides narration, music, sound effects, verbal messages, such as greetings or acknowledgement of an event such as a birthday, wedding or other special occasion or other information about the PictoKids Adventure Multi-Dimensional Presentation and its characters and things. The Display Board requires assembly using Lego type building blocks or other structural pieces that create a work surface to organize and display the printed PictoKids cutouts. The printed cutouts may adhere to the work surface using labels or lining the surface with felt or other fabric that a fabric fastener such as Velcro will adhere to and provide for the printed cutouts to be removed and replaced.

Multi-Dimensional, as it pertains to the PictoKids Adventure Presentation, refers to the transformation and expansion of a basic one word textual description into a dynamic pictorial representation that reflects a series of conventional dimensions. A first dimension, as an example in this context, may simply be a one word textual description of a story (e.g. Xmas). A second dimension is a pictorial 2D representation of Xmas for example a Christmas tree. A third dimension is a transparent overlaid layer on that 2D picture such layering a PictoLayer of candy canes or presents over the 2D Christmas Tree. This is done by placing a shaped, cropped and sized additional static two-dimensional pictorial element of a candy cane for example within a transparent layer to form a Trans-Snip. This third dimension creates a layered Composite Image formed from a number of layered Trans-Snips. A fourth dimension may be the addition of time, performed in PictoStories by combining a sequence of dynamic layered Composite Images creating a time sequence or time relationship that presents the events, actions and outcomes of the story. Santa's Sleigh may appear in the sky over the Christmas Tree, for example. A fifth dimension is an infinitely variable set of Enhancements that provide action, movement and depth to the story. In point of fact, Enhancements may be seen as extending the story beyond the four normally used dimensions, and into many-dimensions to create an adventure that intrigues, entices and entertains the Users of the E-Enhanced Multi-Dimensional PictoKids Software Application. In this example Santa's sleigh swoops down and places a gift under the Christmas Tree with a song such as “We wish You a Merry Christmas!” playing in the background.

### Modules of the PictoKids Application Software

The PictoKids Software Application comprises three Modules A, B, and C where Module A constructs the series of Montage Pages (in the form of pictorial image montages) that include the pictorial representations of a Major Theme and Theme Sub-Topics, and Image Selector Montage Pages that are presented to a User in Module C. Module A also includes a Textual Storyline Generator which expands, extends and textually structures the Scenes and Part Scenes for the PictoKids Adventure storyline. The Scenes and Part Scenes become the structure and layout of a blank Pictorial Architectural Blueprint.

Module B includes the Pictorial Architectural Blueprint Generator and the Production Tools to develop the PictoStorys within the Architectural Blueprint workspace. The PictoStorys are further enhanced within the Architectural Blueprint using the Enhancements Generator to dynamically transform the PictoStorys into the Multi-Dimensional PictoKids Adventure Presentation. Module C includes the Pictorial Overlay Interface (POI) Technology that presents features of the PictoKids Software to a User in a series of Montage Pages. These Montage Pages include the Major Themes and Theme Sub-Topics that are chosen by the User. The chosen Theme and Theme Sub-Topics are used to develop the PictoKids Adventure storyline that are used to structure the Scenes and Part Scenes in the blank Architectural Blueprint. The Image Selector Montage Pages are also presented to the User to populate the Scenes and Part Scenes of the structured blank Architectural Blueprint. These Image Selections by the User conform to the characters, settings, actions and outcomes of the structured Scene and Part Scene of the PictoKids Adventure Presentation. The POI Technology presents the Montage Pages and features in substantially pictorial formats that are sized to fit and be visible on any operating system, tablet, computer platform, or any electronic device such as the smallest cellular phone, or smart phone, IPod, IPad, tablet, laptop, or personal computer. The User input to choose or select the pictures and images may be made using a phone number pad, a keypad, a touchscreen, a mouse, or any other visual or auditory independent interface. The POI Technology of the PictoKids Application Software of Module C also provides control tools for the User to choose, email and print the Presentation, Composite Images and the PictoLayers from the PictoKids Adventure Presentation.

It is important to understand that there are two very different and separate transformations and/or processes related to a either a ‘choice’ or a ‘selection’ by the User where a Theme ‘choice’ is used by the PictoKids Application Software to structure the Scenes and Part Scenes and thereafter to narrow and direct the ‘selection’ of the subsequent pictorial images that will be presented in the Image Selector Montage Pages based on the structured Scenes and Part Scenes. The User's selections from these Image Selector Montage Pages advance the PictoKids Adventure storyline and populate the blank Architectural Blueprint. A choice page or a selection page, which are both constructed in Module A, are presented to the User using the same Montage Page Interface known as Pictorial Overlay Technology to make these choice-selections. In this embodiment “CHOOSING” refers to a theme choice and “SELECTING” refers to an image selection that is of a reduced number of images determined by the storyline structure that is based on the Major Theme choice.

### Module A: Major Themes and Theme Sub-Topics Choice Montage Pages

In order to develop the PictoKids Adventure, a Choice Generator within Module A structures a montage of pictures for a variety of Major Themes and Theme Sub-Topics into Theme Choice Montage Pages. The Major Theme and Theme Sub-Topics chosen by a User then leads to the reduction of selectable images presented to the User for each of the Image Selector Montage Pages for each of the Scenes and Part Scenes of the structured PictoKids storyline. The Major Themes may span a broad range of topics to entice a User to creatively develop their own PictoKids Adventure. In a first example, a Major Theme of “What Do I Want To Be When I Grow Up?” may be presented as a Theme Choice Montage Page with pictures of people in different careers such as pictures of an Explorer; a Super Hero; a Newscaster, an Astronaut, a Scientist, a Gardener, a Policeman, or a Doctor. The Theme Sub-Topics, Montage Page may then present a series of pictures of theme related ideas or Theme Settings which form a subset and may apply to the PictoKids Adventure Major Theme chosen.

A User's choice of an Astronaut will narrow the Theme Sub-Topics to settings that are based on the chosen Theme. Module A will structure the Theme Sub-Topic Choice Montage Page with settings based on Outer Space, such as Moon Exploring, the surface of Mars, or the rings of Saturn and others. The Storyline Generator of Module A applies the KeyConcepts Query to the structured and formatted Scenes and Part Scenes for the PictoKids Adventure Storyline based on the Major Theme and Theme Sub-Topic. Module A then structures the Image Selector Montage Pages with images based on the KeyConcepts, and the formatted Scenes and Part Scenes.

In this example, Module A/B, using KeyConcepts Queries may structure a part scene related to modes of transportation to include spaceships within the Image Selector Montage Page and then, for the same or future Part Scene, present images for characters which may include aliens and then in further Image Selector Montage Pages, for even later part scenes, images for events and outcomes that may happen to an Astronaut in the PictoKids Adventure. The Image Selector image options for the User to select are therefore narrowed based on the structured Scenes and Part Scenes.

In a first embodiment, the PictoKids Adventure chosen from a Major Theme may be structured with three Scenes, each representing a different PictoStory as defined in previous patent applications noted and incorporated herein by reference. Each Scene is constructed to apply and comply with the applied KeyConcepts Query and the Image Selector Montage Pages are structured based on the formatted storyline. In a first example, the Storyline Generator may structurally format the storyline three Scenes and five Part Scenes with for example up to eight PictoLayers in each Scene and Part Scene from the responses to the KeyConcepts Query that may include questions such as who, what, where, etc. From this storyline based on the Major Theme and Theme Sub-Topic, the millions of pictures that may be used by the PictoKids Software are grouped and categorized based on the KeyConcepts Query to the Scenes and Part Scenes to assist in the creation of the Image Selector Montage Pages within Module B. This categorization and creation of the easily reviewed Montage Pages reduces the total number of pictures on his device to a reasonable number of around 500 images for the User to select from for each Scene and Part Scene with 8 selection options presented on each Page. More Theme Choice Options for Major Themes and Sub-Topics with more Image Selector Montage Pages are available through an internet connection to a server.

### Module A: Storyline Generator

The Storyline Generator of Module A of the E-Enhanced Multi-Dimensional PictoKids Software Application constructs storylines based on the Major Theme and Theme Sub-Topic choices. The storyline is extended into Scenes and Part Scenes and the series of Image Selector Montage Pages are constructed based on the Scenes and Part Scenes of the storyline. Through the application of the KeyConcepts Query to the structured Scenes and Part Scenes, a Textual Outline is constructed. In this top down approach the Textual Outlines and Summary extend and expand the number and format for the Scenes and Part Scenes where each Part Scene may represent a required answer to one of the 6 W Cool questions of Where? When? Who? What? How? Why? What Happens? And Wow! Or other questions based on the chosen Themes. Using these textual elements, the Storyline Generator formats the layout of a blank Architectural Blueprint with the Scenes and Part Scenes that will be structured to be populated with the location, the timeframe, the characters, the events, the actions and the outcomes of the PictoKids Adventure from the User's image selections. The Pictorial Architectural Blueprint is populated with the described textual elements from Module A and a series of placeholders for each Part Scene for the image that will be used to prompt and lead a User to select an image to represent the KeyConcepts from the Textual Outline. The User's image selections of Module B are transformed to pictorially represent the Basic Idea and actions of the Scenes and Part Scenes of the PictoKids Adventure Presentation. The textual elements of each Scene and Part Scene are derived from answers to the 6 W Cool questions as applied through the KeyConcepts Querys.

The Major Themes and the Theme Sub-Topics also determine how to populate the Architectural Blueprint. The structure of the Architectural Blueprint is also used to develop a Referenced Page Map that includes a Coordinate File Naming Structure to store the PictoLayers and their Components and Sub-Components within a Data Store Resource.

### Module B: The Pictorial Architectural Blueprint and Blueprint Generator

Within Module B, the Architectural Blueprint will be used to construct the sequence of PictoStorys that will be pictorial representations of the settings, characters, events and outcomes for the Scenes and Part Scenes that will be included within the PictoKids Adventure Presentation. The features of Module B that construct the PictoStorys are not available to the User however the image selections of the User are used to create the PictoLayers that make up the PictoStorys in the PictoKids Adventure Presentation. The Textual Outlines are used to lead a User through each of the Scenes and Part Scenes and select images that conform to the KeyConcepts Queries as the basis to dynamically transform the image selections. In this bottom up approach, the Image Selection Generator provides a series of Image Selector Montage Pages that include Raw Images that are selected by the User and are used to construct these pictorial representations and develop a sequence of PictoStorys.

The User's selected Raw images from the Image Selector Montage Pages are using the PictoLayer Generator stylized by shaping, cropping, and sizing the selected Raw Images. The PictoLayer Generator then removes the white background from the shaped, cropped, and sized Pictorial Element by positioning the element within a blank transparent page to form a Trans-Snip. The Trans-Snip Layers are then aligned using a PictoComposite Generator to form a Composite Image that corresponds and conforms to the textual element of a Part Scene from the storyline. The Composite Image is used as part of the PictoStory. The Composite Image may be formed from any number of Trans-Snip Layers with each layer corresponding to images required to be selected based on the Textual Outline for the 6 W COOL questions of 1. Who?, 2. What?, 3. Where?, 4. When?, 5. Why?, 6. How?, 7. Wow! What happens? and 8. Enhancement. The Composite Image may represent for example an event where the PictoKids Adventure takes place as a Part Scene of the PictoKids Adventure Presentation. The Composite Image with the Trans-Snip elements and Raw Image are structured as a Composite Image Page that populates the Architectural Blueprint with the Textual Outlines and Textual Outline Summary as part of a PictoStory. In this example, a series of five Composite Images are used to complete a PictoStory. The PictoStory Page with the Composite Images, each of their Summary Textual Outlines, and a PictoStory Summary Textual Outline are also located within the Architectural Blueprint. A PictoStory may form a Scene for the PictoKids Adventure and three Scenes may make up the full PictoKids Adventure Presentation.

The Blueprint Generator Production Control Tools are used to create, arrange, modify, enhance, edit and order the Composite Image Pages into PictoStorys for the PictoKids Adventure Presentation. The Referenced Page Map provides navigation tools to easily access each Component and Sub-Component to modify and enhance the PictoLayers. The Referenced Page Map provides for the association of an Enhancement with a Trans-Snip, a Composite Image or a set of Composite Images or at any dimensional level of the PictoStory. Enhancements provide contextual details to amplify and assist in the presentation of the settings, characters, actions and outcomes of the PictoStorys with no limit—except the imagination—as to what an enhancement might actually be and therefore is infinite in contextual content that may be presented within the PictoKids Adventure Presentation.

Using the Enhancements Generator, the PictoKids Adventure is dynamically transformed by adding one or more varied media formats, such as, Text, Narration Text, Narration Record, Song, Music, Sound Effects, Video, Video Effects, Animation, or any other supportive Element. The Enhancement may also be in the form of a hyperlink, Subroutine or other script that links a designated access point within a Resolution Cell Map of the Trans-Snip or the Referenced Cell Map within the Composite Image to activate and/or run the additional information about the Basic Idea of the PictoStory within the PictoKids Adventure Presentation.

The linked Enhancements are stored within the secure, Data Store Resource using the Coordinate File Naming Structure based upon the Referenced Page Cell Map where a Component, Sub-Component or Enhancement is stored with a randomized, scrambled and/or encrypted file name that corresponds to a coordinate of the Referenced Page Cell Map that provides for Activation of any Component by accessing any or all referenced coordinates within the Cell Map. Importantly, while the content of each file is based on the applied KeyConcepts to the Scenes and Part Scenes from for example the responses to the 6 W COOL questions of Who?, What?, Where?, When?, Why?, How?, and Wow What happens?, the filename is not in any way associated with the content of the file but instead is specifically associated with the randomized, scrambled, encrypted Cell Map Coordinate.

This unique file structure provides for an Alternative Component that meets similar criterion of the KeyConcepts to be available to the User in the Image Selector Montage Page and be interchanged by using a matching randomized, scrambled or encrypted coordinate filename. The Alternative Component may be a different character, a new setting, or a different event, action and/or outcome that may be viewed in a temporary folder and then if selected be seamlessly replaced within a Scene or Part Scene of the PictoKids Adventure Presentation by transferring the Alternative Component to an active folder and thereby overwriting the currently Active Component. The flexibility to effortlessly change any component within the PictoKids Adventure Presentation and the multitude of storylines constructed by the Storyline Generator provides infinitely variable events, characters and outcomes for the PictoKids Adventure Presentation to engage and entertain a User. In a final step, the Production Control Tools of the Blueprint Generator of Module B enhance the PictoStorys of the Scenes and Part Scenes with audio and visual effects, narration, background music or other features to transform the pictorial representations from a static state to a dynamic state to be presented to a User using the Pictorial Overlay Interface (POI) of Module C.

### Module C: The Production Presenters

For a User of the PictoKids Application Software, the Pictorial Architectural Blueprint and the structure of the PictoStorys, PictoLayers and Textual Outlines are not viewable and only portions of the features and control tools of the Storyline and Blueprint Generators are available to the User. In accessing the software, the User instead is presented with the Pictorial Overlay Interface (POI) that presents the Major Theme and Theme Sub-Topics Choice Montage Pages for the User to choose from. For example a Major Theme Choice Montage Page may include a number of general topics for the PictoKids Adventure, such as choices for the PictoKids to be an explorer with an adventure Theme Sub-Topic of a trip into the deepest jungle or as a mountain climber trying to reach the highest peak, or as a policeman catching a bank robber. The Major Theme and Theme Sub-Topic choices direct the Choice Generator of Module A to construct Image Selector Montage Pages based on the chosen Themes.

As an example, after a User chooses the Major Theme, the Storyline Generator structurally formats the Scenes and Part Scenes for the PictoKids Adventure that will lead a User to populate the blank Architectural Blueprint with images that conform to the KeyConcepts of each Scene and Part Scene. From the Major Theme and Theme Sub-Topic choices, the Storyline Generator may structure Scenes and Part Scenes that include KeyConcepts such as where the adventure may Start From, where the User will Go To, when in the past, present or future the PictoKids Adventure takes place, who they will be, who they will travel with, and how they will get there for Scene 1 for example. The Choice Generator structures images within the Image Selector Montage Pages based on the structured Scenes and Part Scenes. The User selects an image for each Part Scene of Scene 1. Hidden to the User, the Storyline Generator accepts these selections and through the stylization process develops the Composite Images for the Part Scenes that are used in a PictoStory that will be Scene 1 for the PictoKids Adventure Presentation.

With each User selection the PictoKids Application Software secretly performs the stylization process to each of the images to create the PictoLayers and PictoStorys for each Part Scene and Scene. If outer space is chosen by the User as the Major Theme and Mars is chosen as the Theme Sub-Topic then as an example the Character Image Selector Montage Page may include an astronaut, a scientist, an engineer, a doctor, an alien, a space monster or other characters that may be selected as possible characters that the User may want to be or the characters they want to go with in the PictoKids Adventure. The PictoKids Software Application also provides for the User to upload images of themselves and their friends or images of anyone they would like to be characters in the PictoKids Adventure. Importantly, the structure of the Scenes and Part Scenes for the storyline causes the POI to present the Image Selector Montage Pages developed to conform with and provide images that represent the KeyConcepts of each Scene and Part Scene. Each selection from the variety of images for the User to select from is secretly transformed into the characters, events, actions and outcomes for the structured Scenes and Part Scenes of the pre-arranged storyline to be used within the PictoKids Adventure Presentation.

Each of the User's choices for the Major Theme and Theme Sub-Topic and the image selections are located within the Referenced Page Map of the Architectural Blueprint to be pictorially stylized and dynamically transformed behind the scenes using the Blueprint Generator of Module B. The Trans-Snips are used to create a Composite Image that is then used within a PictoStory to represent a Scene or Part Scene in the PictoKids Adventure Presentation. Each selection by the User activates the PictoStory Application Tools to create the Components and Sub-Components of the PictoStorys that will be used in the Scenes and Part Scenes of the PictoKids Adventure. Each Theme choice directs the storyline structure for the Scenes and Part Scenes and the content of Image Selector Montage Pages presented for the events, actions and outcome of the Scenes and Part Scenes of the PictoKids Software. Hidden from the User, PictoStorys are created from these selections and the PictoStorys are enhanced using audio, narration, animation, video, video effects, sound effects, slide shows, image Components, etc. or any variation of Enhancements or effects to create the User designed dynamic E-Enhanced Multi-Dimensional PictoKids Adventure Presentation.

As an example, a Major Theme choice leads to an Architectural Blueprint, which is structured into Scenes and Part Scenes. The Storyline Generator further develops a storyline that not only structures the Scenes and Part Scenes but also automatically applies the 6 W Cool questions to the Scenes and Part Scenes to create Textual Outlines based on the chosen Theme. The Image Selection Generator then structures the Image Selector Montage Pages that include the characters, locations and actions that will be selected by the User to create the PictoKids Adventure Presentation.

The user populates this blueprint with selected images, for example a series of geographic image locations that may be selected for where the PictoKids Adventure will take place. For example, in a scene, the image selection of a French setting may become a Composite Image that may include Trans-Snips of the Eiffel Tower, the Arch de Triumph, the French flag and croissants to encapsulate pictorially, and emotively project the country of France. One of the Image Selection Montage Pages may include an event selected by the User that is secretly transformed to show why they are going to the location in the PictoKids Adventure. Behind the scenes, the selected image that conform to the KeyConcepts of the event is stylized by the PictoLayer Generator of the PictoKids Software Application to create Trans-Snips and Composite Images to statically and pictorially display the event. Behind the scenes, the selected image and these PictoLayers are populated within the Architectural Blueprint to develop a dynamic presentation of the event that may include selected and transformed pictorial representations of the characters within the PictoStory for the Scenes and Part Scenes to be used in the PictoKids Adventure Presentation.

In creating the PictoStory, an in-depth representation of the KeyConcepts from the Scenes and Part Scenes is created through the randomization, sizing, locating and populating stylization process to form a Trans-Snip and Composite Image. An image selected for a character may maybe an image of the User, a person the User knows or a famous actor within the Image Selector Montage Page to truly personify and with Enhancements dynamically transform the image into an active, engaging character. Using the PictoKids Adventure Software Application, the transformed PictoLayers are synchronized and sequenced to produce a complete contextual display of the selections from the Image Selector Montage Pages and integrate these into the E-Enhanced Multi-Dimensional Presentation.

The Pictorial Overlay Interface (POI) further includes pictorial Introductions, Explanations and Navigation Presentations that efficiently present tools and features of the software so that the User may immediately grasp the operation of the PictoKids Software Application. In these presentations, pictures and videos NOT words do the talking. Control options are also presented pictorially not using normal drop down functions but instead presenting pictorial overlays of tool options that may be chosen by a User.

Other features that are subsets of the Blueprint Generator are also provided for a User to order, enhance, playback, review, and add a message to the PictoKids Adventure Presentation. A User may playback the PictoKids Adventure Presentation to transform the PictoStorys from static pictorial representations to a dynamic enhanced audio and visual presentation. All or any portion of the E-Enhanced Multi-Dimensional PictoKids Adventure Presentation may be activated so that it may be viewed by the User. The activation provides for one or more Composite Images, Scenes, Part Scenes, or PictoLayers to be printed on paper, postage sheets, sticker labels or alternatively on transparent film sheets that may be arranged into Collage/Pastiche images or other artistic displays showing the features of the PictoKids Adventure Presentation. The PictoLayers may further be adhered to a fabric fastener such as Velcro and be placed on a fabric fastener such as Velcro lined Display Board or using other attachment means to display and create PictoKids Adventure artwork. The Display Board may include digital sound that may play narration, background music or sound effects from the PictoKids Adventure Presentation.

The PictoKids Application Software performs the transformation of a chosen Major Theme by a User into a dynamic Multi-Dimensional PictoKids Adventure Presentation by performing the following process steps of (1) a Major Theme is chosen by the User; (2) a Blank Structure storyline Blue Print is created by the software; (3) Scenes, Part Scenes and PictoStories of that structured Blueprint are populated by images selected by the User that are prompted by the software. Importantly, each Scene, Part Scene, PictoStory, Composite Image or images presented to the User are guided by the application by the software of Key Concept Queries—Who, What Where etc. (4) The PictoKids Application Software transforms, sequences, extracts and enhances the pictorial user input selections to create a dynamic PictoKids Adventure Presentation. This transformation is achieved through Pictorial Overlay Technology, which is a form of Multi-Dimensional Pictorial Presentation described herein and in PictoStory Patent Application 61/705,686. The Pictorial Overlay Technology uses a Pictorial Overlay Interface (POI) based on Pictorial Montages to guide, prompt, explain, print and display the PictoKids Adventure Presentation and the entire PictoKids Application Software process.

This transformation process results in a reduced, practical, manageable image selection method that can be resident on limited memory computers, mobile devices or other electronic communication devices, and thereby providing critical vis a vis time, speed, clarity and ease of use. There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the Components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the invention is to provide a software platform on a computer system that allows a User to transform an idea or concept and create a PictoKids Adventure from a sequence of PictoStorys that are structured into a Multi-Dimensional PictoKids Adventure Presentation defined as an enhanced featured, dimensionally layered, displayable, narrated, musicked, audio/video pictorial presentation.

Another object of the invention is the control of access to the PictoKids Software Application based on available time or points (i.e. PictoCash) and using a PictoPuzzle Identification Code.

Another key object of the PictoKids Application Software of the present invention is the three stage transformation process which results in a reduced, practical, manageable image selection method that can be resident on limited memory devices, and critical vis a vis time, speed, clarity and ease of use.

Another object of the invention is the presentation of software control tools using pictorial overlays not drop down menus.

Another object of the invention is the thematical grouping and presentation of pictures in a 3×3 matrix montage that may be easily reviewed, greatly decreasing the amount of time needed by a User to select an image or choose a theme.

Another object of the invention is the grouping and categorization of millions of pictures that may be based on an infinite variety of themes are narrowed through the structure of the storyline and Scenes and Part Scenes to a series of selections that are stylized and enhanced to be used in the PictoKids Adventure Presentation.

Another object of the invention is the downloading of a reduced number of grouped and categorized pictures that are based on a variety of themes to reduce the amount of images a User selects from.

Another object of the invention is the creation of a series of pre-arranged storylines using the Storyline Generator that structures the layout of a blank Pictorial Architectural Blueprint with Scenes and Part Scenes for the creation of the PictoKids Adventure Presentation.

Another object of the invention is the creation of a User designed PictoKids Adventure Presentation by having a User select from a montage of grouped and categorized images, based on a theme and structured storyline, the characters, settings, events, actions and outcomes that are used in the PictoKids Adventure Presentation.

Another object of the invention is the categorization of Raw Images and PictoLayers within a Data Store Resource using a Choice Generator and displaying a functional group of PictoLayers that may be Composite Images or Raw Images in an Image Selector Montage Page based upon the storyline.

Another object of the invention is to acquire and process a Basic Idea that is related to a Major Theme and Theme Sub-Topic to expand and extend the Basic Idea both textually and pictorially.

Another object of the invention is the stylizing by shaping and cropping from any portion of a selected Raw Image or PictoLayer, and sizing to form a pictorial element which conforms to textual elements of the a Scene or Part Scene.

Another object of the invention is to locate a selected Raw Image or portion of the selected Raw Image or Pictorial Element on a transparent blank having Resolution Cell Map thereby removing the white background to form a transparent cropped, shaped, sized Trans-Snip.

Another object of the invention is to layer the Trans-Snips to form a layered Composite Image and associate the Composite Image with a Referenced Cell Map using the PictoComposite Generator.

Another object of the invention is to locate the Composite Images with expanded Textual Outlines within the Architectural Blueprint to be used to form a series of PictoStorys that represent characters, settings, events, actions and outcomes that may be used within the PictoKids Adventure Presentation.

Another object of the invention is to integrate audio, video, text, pictorial and non-pictorial Enhancements to a Trans-Snip, a layered Composite Image, a group of layered Composite Images, or to a PictoStory to provide additional Multi-Dimensional information about the Basic Idea based on a Major Themes and Sub-Topic Theme to create a User designed Enhanced Multi-Dimensional PictoKids Adventure Presentation.

Another object of the invention is using control system tools of the Blueprint Generator to create, navigate, order, modify, enhance, edit, playback, review, combine, render, realize and activate to produce an E-Enhanced Multi-Dimensional PictoKids Adventure Presentation.

Another object of the invention for the E-Enhanced Multi-Dimensional PictoKids Application Software is the structured series of file folders within the secure, Data Store Resource to store Raw Images, Trans-Snips, Composite Images and Enhancements with randomized, scrambled or encrypted file names based on a Coordinate File Naming Structure of the Referenced Page Map of the formatted Architectural Blueprint to index and categorize data within the file folder structures.

Another object of the invention is the seamless replacement of any Raw Image, Pictorial Element, Trans-Snip, Composite Image, Enhancement, PictoStory and/or Component or Sub-Component of a PictoStory by selecting using production control tools of the Blueprint Generator an Alternative Component from the categorized and indexed Image Selector Montage Pages and renaming the Alternative Component to match the randomized, scrambled and/or encrypted Coordinate File Naming Structure of the Referenced Page Map of the Architectural Blueprint for the Interchangeable Component thus requiring no change of basic code to create infinite variations of different PictoKids Adventures.

Another object of the invention is providing for the User to upload an image of themselves, or others to be chosen as characters within the PictoKids Adventure Presentation.

A further object of the invention is the printing of any PictoLayer of the PictoKids Adventure Presentation on paper, transparent sheets, postage sheets, sticker labels, fabric fastener such as Velcro adhered material or fabrics and other materials that provide for the User to create and manufacture vibrant displays and Collage/Pastiche images on digital sound Display Boards.

A further object of the invention is the inclusion of a prologue and epilogue that may provide a message to a loved one or acknowledgement of a special holiday or event that may be emailed to the User with the PictoKids Adventure Presentation.

A further object of the invention is displaying Montage Pages so that they are pictorially sized and formatted to fit and be visible on any electronic communication device including the smallest cellular phone so that a choice may be made using the phone number pad, or touchscreen.

A further object of the invention is that all PictoKids Adventure Presentations are presented in pictorially formats that allow free transportation across many different size computer and electronic device platforms such as Smart Phone, IPhone, IPod, IPad, tablet, laptop, Personal Computer, and other formats independent of type of user interface that may include a mouse, touch screen, keyboard verbal command or other input.

A further object of the E-Enhanced Multi-Dimensional PictoKids Application Software is the transformation of a chosen Theme into a dynamic, enhanced, overlaid visually ‘Show not Tell’ representation of a storyline structured into the Scenes and Part Scenes that have KeyConcepts applied to create characters, settings, actions and outcome PictoStorys to be used in a User created PictoKids Adventure Presentation.

A still further object of the invention is the review of PictoKids Adventure Presentation competitively to provide for a User to receive additional time or points (i.e. PictoCash) for access to the PictoKids Software Application or other rewards.

The present invention is related to a software system for the creation of a user designed enhanced multi-dimensional pictokids presentation, comprising, application software installed on a computer system, the application software comprising, a blueprint generator, a production populator, a storyline generator, a pictolayer generator, a pictocomposite generator, a pictostory generator, an enhancements generator, a production presenter, and wherein the blueprint generator formats an architectural blueprint, the production populator populates the architectural blueprint with a chosen theme and theme sub-topic, the storyline generator structures a storyline having a plurality of scenes and part scenes based on the chosen theme and theme sub-topic, the pictolayer generator stylizes a plurality of trans-snips from a plurality of images pictorially representing the plurality of scenes and part scenes, the pictocomposite generator layers the plurality of trans-snips to form at least one composite image, the pictostory generator creates at least one pictostory from at least one composite image representing one of at least a scene and part scene from the plurality of scenes and part scenes, the enhancements generator associates at least one enhancement with one of at least one trans-snip from the plurality of trans-snips, at least one composite image, at least one pictostory and at least one scene or part scene from the plurality of scenes and part scenes within the architectural blueprint, and the production presenter sequences at least one pictostory to create an enhanced multi-dimensional pictokids presentation.

In the software system for the creation of a user designed enhanced multi-dimensional pictokids presentation the themes and theme sub-topics are presented to a user using the pictooverlay interface. The software system for the creation of a user designed enhanced multi-dimensional pictokids presentation may also require access to the software system through the completion of a pictoidentity. The software system for the creation of a user designed enhanced multi-dimensional pictokids presentation further comprises one of at least an introduction presentation, an explanation presentation and a navigation presentation.

In the software system for the creation of a user designed enhanced multi-dimensional pictokids presentation wherein the themes and theme sub-topics are chosen from at least one of a type of character, a start from location, a destination, a time, a participant, a companion, a method of transportation, an event, an adversary, a reason, what happens, how it happens and the outcome of what happens. Also in the pictorial representation software system for the creation of a user designed enhanced multi-dimensional pictokids presentation a plurality of images is presented to represent the themes and theme sub-topics and a trans-snip from the enhanced multi-dimensional pictokids presentation may be printed on transparent sheets to form a collage image, on pre-formed adhesive label cut outs, and on material adhered to a fabric fastener to be placed on a fabric fastener lined display board. The software system for the creation of a user designed enhanced multi-dimensional pictokids presentation further comprises control tools to email the enhanced multi-dimensional pictokids presentation.

The present invention is further related to a method of transforming a theme choice by a user into a pictorial presentation, comprising the steps of accessing application software installed on a computer system, displaying a plurality of images representing themes for a user to choose from, accepting a user's choice for a theme, displaying a plurality of images representing a series of theme sub-topics for a user to choose from, accepting a user's choices for a series of theme sub-topics, populating an architectural blueprint with the chosen theme and theme sub-topics, structuring a storyline based on the chosen theme and theme sub-topics, creating a plurality of pictolayers, layering the plurality of pictolayers, developing pictostorys from the plurality of layered pictolayers, associating at least one enhancement with one of at least the pictolayers, layered pictolayers and pictostorys, rendering at least the pictolayers, layered pictolayers, pictostorys and enhancements to create a pictorial presentation.

The method of transforming a theme choice by a user into a pictorial presentation further comprises the steps of structuring the storyline into scenes and part scenes applying a key concepts query to develop a textual outline of each scene and part scene. The method also further comprises the step of accessing the application software using a pictoidentity and presenting one of at least an introduction presentation, an explanation presentation and a navigation presentation to a user. The method of transforming a theme choice by a user into a pictorial presentation further comprises the step of choosing themes and theme sub-topics from at least one of a type of character, a start from location, a destination, a time, a participant, a companion, a method of transportation, an event, an adversary, a reason, what happens, how it happens and the outcome of what happens. The method of transforming a theme choice by a user into a pictorial presentation also further comprises the step of printing at least one pictolayer on transparent sheets, on pre-formed adhesive label cut outs and on material adhered to a fabric fastener to be placed on a fabric fastener lined display board. The method also comprises the step of emailing the pictorial presentation restricting access to the application software system and pictorial presentation.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1: FIG. 1 is a block diagram of a first embodiment of the computer platform of the E-Enhanced Multi-Dimensional PictoKids Application Software of the present invention;

FIG. 2: FIG. 2 is a block diagram illustrating the Modules A, B, and C that in a first embodiment make up the E-Enhanced Multi-Dimensional PictoKids Application Software of the present invention;

FIG. 3: FIG. 3 is a block diagram illustrating a first embodiment of the components of Module A of the PictoKids Application Software in a first embodiment of the present invention;

FIG. 4: FIG. 4 is a block diagram representation of the components of the Storyline Generator and the generated enhanced Textual Outlines of a first embodiment of the present invention;

FIG. 5: FIG. 5 is a block diagram illustrating a first embodiment of the components of Module B of the PictoKids Application Software in a first embodiment of the present invention;

FIG. 6: FIG. 6 is a block diagram of a first embodiment of the Components and Sub-Components of the PictoLayers in a first embodiment of the PictoKids Application Software;

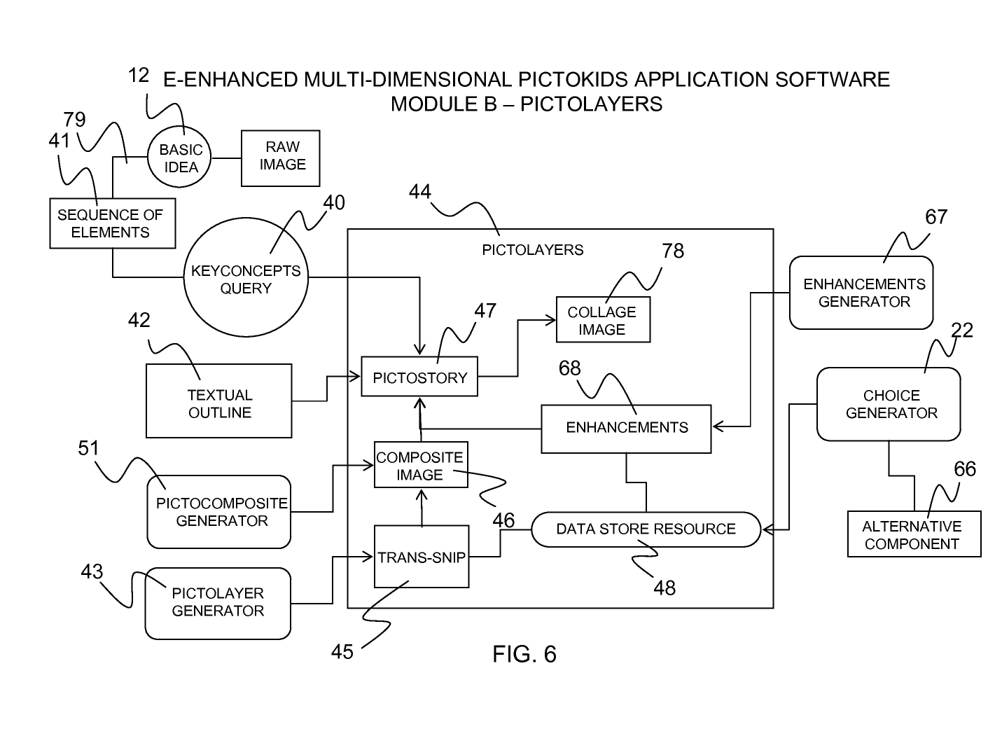

FIGS. 7A-7D: FIGS. 7A-7D are diagrammatic representations of the operation of the PictoLayer Generator in forming a Trans-Snip from a Raw Image in a first embodiment of the present invention;

FIG. 8: FIG. 8 is an illustrative representation of a Trans-Snip Page of a first embodiment of the present invention;

FIG. 9: FIG. 9 is an illustrative representation of a Composite Image Page of a first embodiment of the present invention;

FIG. 10: FIG. 10 is a diagrammatic representation of a first embodiment of a populated PictoStory BluePrint in a first embodiment of the present invention;

FIGS. 11A and 11B: FIGS. 11A and 11B are illustrative representations of a Referenced Page Map and Referenced Page Cell Map of a first embodiment of the present invention;

FIG. 12: FIG. 12 is illustrative representation of a Referenced Page Map of a first embodiment of the present invention;

FIG. 13: FIG. 13 is a block diagram illustrating a first embodiment of the components of Module C of the PictoKids Application Software in a first embodiment of the present invention;

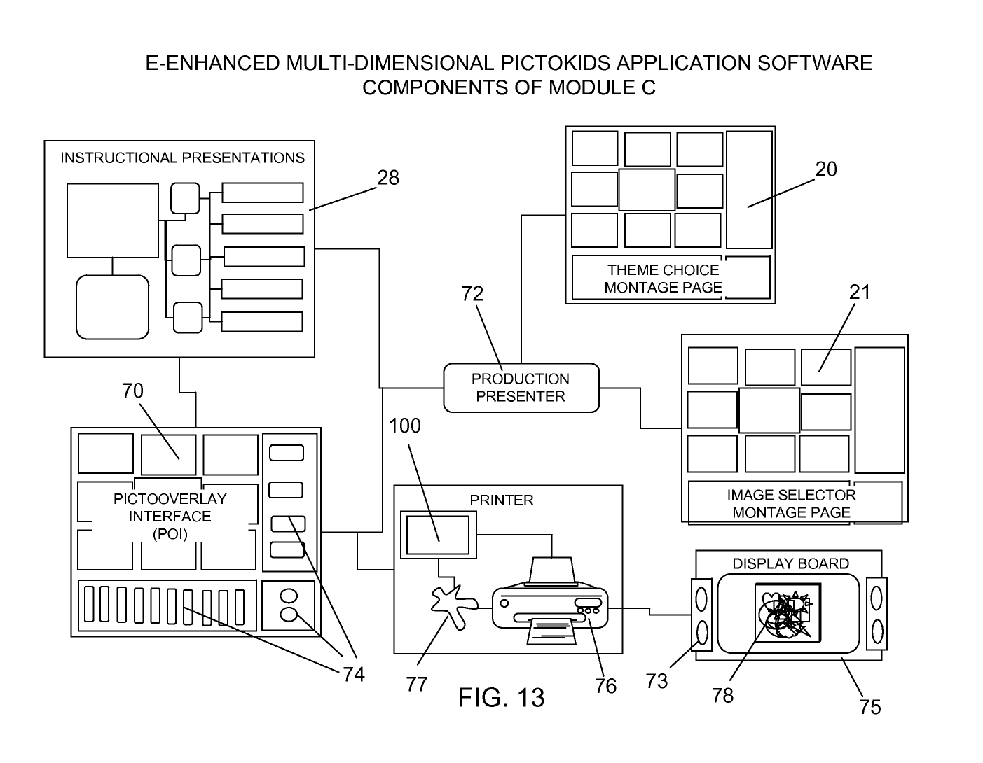

FIG. 14: FIG. 14 is a block diagram illustrating a first embodiment of a structured storyline developed by the Storyline Generator of the PictoKids Application Software in a first embodiment of the present invention;

FIG. 15: FIG. 15 is a diagrammatic representation of a first embodiment of Major Theme Choice Montage Page in a first embodiment of the present invention;

FIG. 16: FIG. 16 is a diagrammatic representation of a first embodiment of an Image Selector Montage Page in a first embodiment of the present invention;

FIG. 17: FIG. 17 is a diagrammatic representation of a first embodiment of Start From and Go To selections from a User from the Image Selector Montage Pages in a first embodiment of the present invention;

FIG. 18: FIG. 18 is a diagrammatic representation of a first embodiment of selections made by a User from the Image Selector Montage Pages for Scene 1 of the PictoKids Adventure Presentation in a first embodiment of the present invention;

FIG. 19: FIG. 19 is a diagrammatic representation of a first embodiment of an Image Selector Montage Page for Scene 2 used in Module B in a first embodiment of the present invention;

FIG. 20: FIG. 20 is a diagrammatic representation of a first embodiment of a populated PictoKids Character PictoStory BluePrint in a first embodiment of the present invention;

FIG. 21: FIG. 21 is a diagrammatic representation of a first embodiment of a populated Architectural Blueprint PictoKids Scene 2 BluePrint in a first embodiment of the present invention;

FIG. 22: FIG. 22 is a diagrammatic representation of a first embodiment of images selected by the User for Scene 2 in a first embodiment of the present invention;

FIG. 23: FIG. 23 is a diagrammatic representation of a further embodiment of an Image Selector Montage Page in a first embodiment of the present invention;

FIG. 24: FIG. 24 is a diagrammatic representation of a still further embodiment of an Image Selector Montage Page in a first embodiment of the present invention;

FIG. 25: FIG. 25 is a diagrammatic representation of a first embodiment of the PictoStorys from the PictoKids Adventure Presentation in a first embodiment of the present invention;

FIG. 26: FIG. 26 is a diagrammatic representation of a first embodiment of a Production Presenter of Module in a first embodiment of the present invention; and

FIG. 27: FIG. 27 is an illustrative representation of a Collage Image that may be printed in a first embodiment of the present invention;

### DETAILED DESCRIPTION OF THE INVENTION

Using the PictoKids Software Application, the PictoKids Adventure Presentation is created from pictorial theme choices and image selections by a User that are transformed into a sequence of PictoStorys that are enhanced by incorporating audio, video, slide, animation, interactive features, effects and other media. The PictoKids Adventure Presentation may be expanded upon by effortlessly modifying characters, features, scenarios, actions and outcomes by using alternative image selections and seamlessly replacing a PictoLayer with in the Presentation. Any Presentation may also be entered in competitions to receive PictoCash and rewards. Turning now descriptively to the drawings, in which similar reference characters denote similar elements throughout the several views, the figures illustrate features of the E-Enhanced Multi-Dimensional PictoKids Software Application.

### PictoKids Application Software Computer Platform

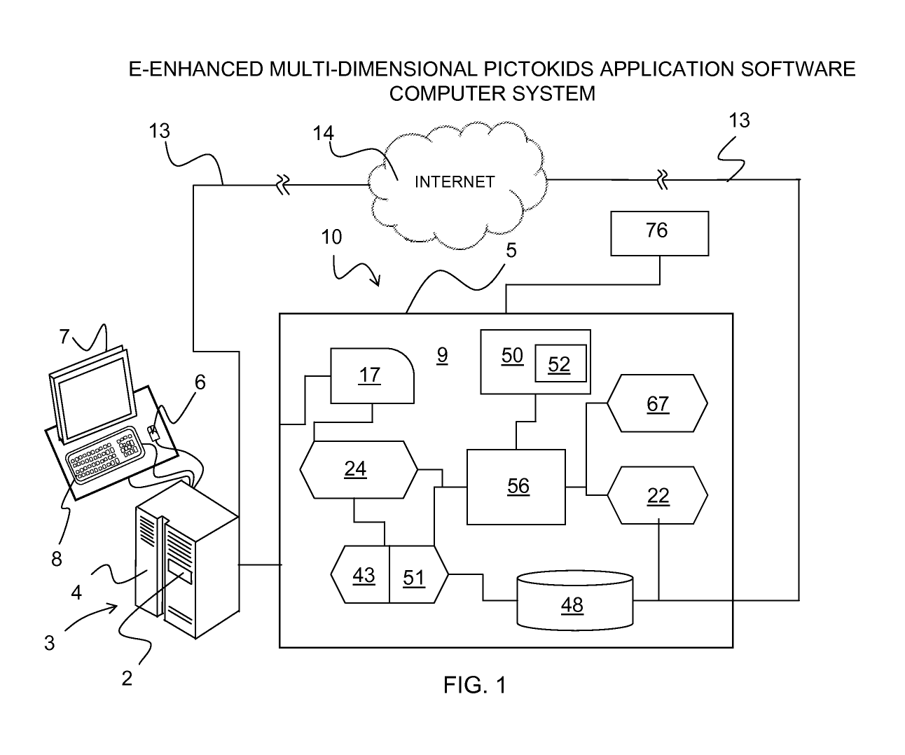

As shown in FIG. 1, in a first embodiment the E-Enhanced Multi-Dimensional PictoKids Application Software may be implemented in computer hardware and computerized equipment. For example, the method can be performed using a system including one or more digital communications devices and/or one or more personal computers and data servers. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for choosing an item and providing input to the processor 5. It is to be appreciated that the input is not limited to the known input apparatus and methods but includes input methods and devices which may yet be developed.

Memory and data storage, in any form, can be included and is illustrated as a hard-disk device such as computer readable storage medium 2, which can include software programs, and is connected to the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. A printer 76 or other output device can also be connected to the processor unit 5 for printing a hardcopy of the PictoLayer 44 or display from the computer system. The processor unit 5 can have a network connection 13, such as a telephone line, network cable or wireless link, to an external network, such as a local area network or the Internet 14.

The output device 7 provides visually to the user transactional, interactive or variable data that has been Subject to transformations. The output device 7 can be a monitor or other visual computer screen or graphical user interface (GUI), a printer or other output device that provides a visual or other representation of a final output from the processor unit 5. The output device 7 can also be an output device that provides the transactional data as a digital file. The processor unit 5 provides means for processing the transactional, interactive or variable data to produce readily discernible, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 can store a computer program product having a program stored in the computer readable storage medium 2, which may include, for example: magnetic storage media such as a magnetic disk or magnetic tape; optical storage media such as an optical disc, optical tape, or machine readable bar code; solid state electronic storage devices such as random access memory (RAM), read only memory (ROM) or flash memory data storage devices. The associated computer program and data server may be implemented through application software 17 on a SaaS (Software as a Service) or on demand computing service such as a Cloud or shared resource database through a web browser. A secure login with password may be provided to remotely access the software 17 through an intranet or internet connection. One or more of the devices to access the application software may be connected wirelessly, such as by a cellular link, Wi-Fi wireless, Bluetooth technology or other technology where the device is either directly connected or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject a result, or may be assisted by data or metadata (data or metadata that may be user supplied, supplied by another computer program or database from a different application or determined by an algorithm). Moreover, the algorithm(s) may interface with a variety of workflow user interface schemes.

In the following description, some features are described as “software” or “software programs”. Those skilled in the art will recognize that the equivalent of such software can also be readily constructed in hardware. Because data manipulation algorithms and systems are well known, the present description emphasizes algorithms and features forming part of, or cooperating more directly with the method and hardware of the presently disclosed invention. General features of databases, digital communications devices, email and computerized systems are likewise well known, and the present description is generally limited to those aspects directly related to the method and related hardware of the invention. Implementation of the present invention may be in conjunction with one or more database management systems (DBMS) such as Oracle, IBM DB2, Microsoft SQL Server, PostageSQL, MySQL, or others using widely supported database languages such as SQL to define and manipulate data and perform data queries. Other aspects of such algorithms and apparatus, and hardware and/or software for producing and otherwise processing the data involved therewith, not specifically shown or described herein may be selected from any such systems, algorithms, Components, and Elements known in the art. The present invention may further be implemented on a secure web server 9 using SSL, SHTTP or other security protocols for encryption and decryption of transmitted data. Data replication and redundancy is performed automatically and all servers are secured in optimal conditions. Further security is provided where each story project is setup using a unique domain name that is accessible only using login identifications and passwords. User logins and preferences link specific user information to their user identification to provide predetermined access to information for each user. Administrative tools within the application software 17 monitor, add or remove users, manage content and set restrictive/predetermined access parameters to users of the system. The presentation parameters within Module C as described in further detail herein may Activate, Present and Print any portion or PictoLayer 44 of the PictoKids Adventure Presentation to provide for a User to form their own artistic designs from the PictoKids creation.

### Details of the E-Enhanced Multi-Dimensional PictoKids Software Modules

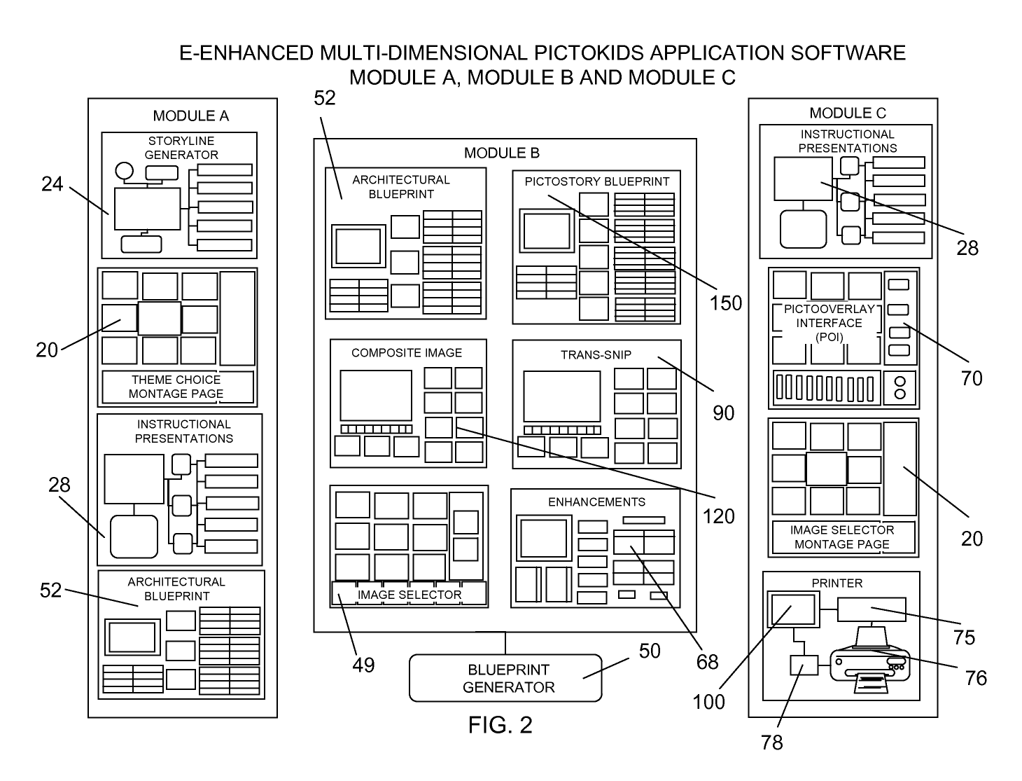

In a first embodiment as shown in FIG. 2, Modules A, B and C of the PictoKids Application Software 10 provide for a User to design a PictoKids Adventure Presentation 100. Module A includes the development of a series of Theme Choice Montage Pages 20 using a Choice Generator 22. A Storyline Generator 24, also included in Module A, develops and structures the story for the PictoKids Adventure and uses this structure to format a blank Architectural Blueprint 52. Module A also includes an Intro-Explain-Navigate Generator 26 that creates the Introduction, Explanation and Navigation Instructional Presentations 28 that pictorially explain how to use the PictoKids Application Software 10.

Module B includes the Architectural Blueprint 52 that is used by the PictoKids Software Application 10 as a workspace that using the Blueprint Generator 50 creates, edits, enhances and produces the sequence of PictoStorys 47 that form the PictoKids Adventure Presentation 100. The Production Populator 56 populates the Architectural Blueprint 52 with the PictoLayers 44 of the created PictoStorys 47 that may be arranged, modified, and edited using the Production Control Tools 54 of the Blueprint Generator. Each PictoStory is structured within the Architectural Blueprint 52 in a PictoStory Blueprint 150 that structures the Composite Images 46, Trans-Snips 45 and Enhancements 68 that make up a PictoStory 47. Within the Architectural Blueprint 52, one or more Enhancements 68 may be associated with any PictoLayer 44 of any PictoStory using the Enhancement Generator 67.

Module C includes the Pictorial Overlay Interface (POI) 70 and Production Presenter 72 to display the Instructional Presentations 28 and to display, send and print the PictoKids Adventure Presentation 100. The Production Presenter 72 of Module C provides additional software tools to add visual effects, narration, background music, a message and other features to the completed PictoKids Adventure Presentation 100. The POI 70 presents the Theme Choice Montage Pages 20 for the User to choose the Major Theme and Theme Sub-Topic from and the Image Selector Montage Pages to select the images that are used to create the PictoStorys for the PictoKids Adventure Presentation. Control Tools 74 to view, email and print the PictoKids Adventure Presentation 100 are also available. Using the Control Tools 74 any portion of the Presentation 100 may be chosen by the User and be sent to a Printer 76 for the User to print one or more PictoLayers 44 on paper, transparent sheets, a fabric fastener sheet such as fabric fastener such as Velcro adhered sheets, or pre-formed Avery label sheets that are formed in the shapes of characters and things from the PictoKids Adventure. The printed PictoLayers 44 may be displayed on a digital sound Display Board 75 to form Collage Images 78 with sound effects, narration or a message for a viewer of the PictoKids Adventure Presentation.

### Details of Model A of the PictoKids Software Application

Module A includes the Intro-Explain-Navigate Generator 26 to create the instructional presentations, the Choice Generator 22 to develop the Theme Choice Montage Pages 20 and the Storyline Generator 24 to formulate the PictoKids Adventure storyline by structuring the Scenes and Part Scenes, and formatting the Architectural Blueprint 52 with the Scenes and Part Scenes of the created storyline.

### Details of Module A: The Intro-Explain-Navigate Generator

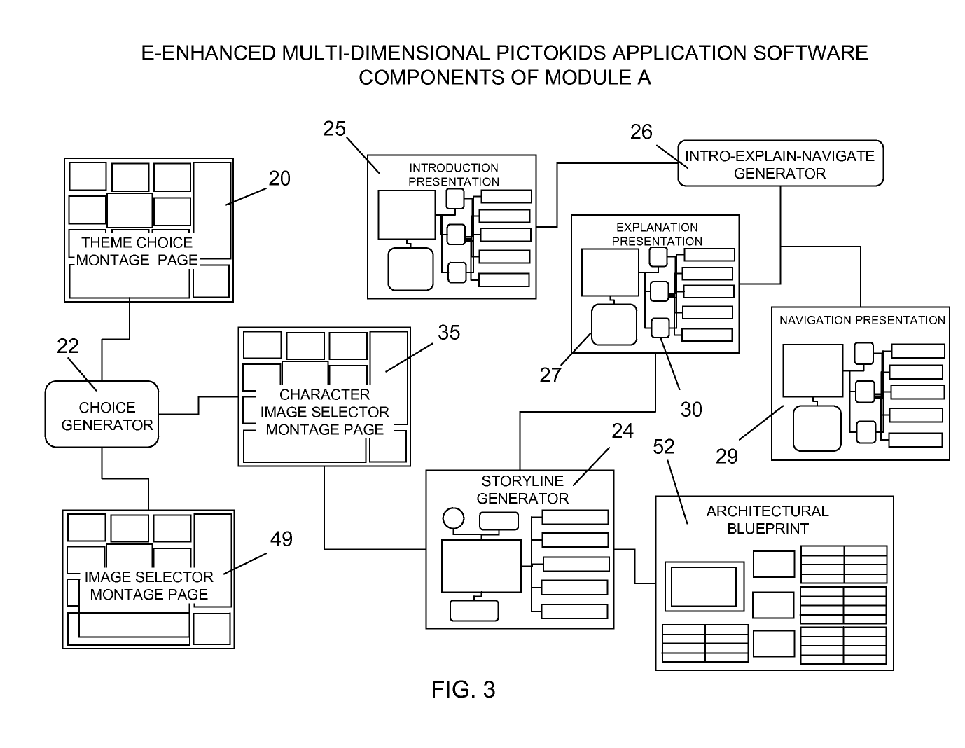

The features of Module A are shown in FIG. 3. A series of PictoKids Introduction, Explanation and Navigation Presentations 28 are developed using the Intro-Explain-Navigate Generator 26 to create a set of pictorial presentations that immediately convey the unique features of the PictoKids Application Software 10. The Presentations 28 are constructed from a series of Enhanced Sequenced Instructional PictoStorys 30 that are formed from layered Composite Images 46 derived from information related to the controls and features of the PictoKids Adventure Presentation 100. The short and comprehensive Presentations 28 provide detail and instruction on using the PictoKids Application Software 10. The Instructional PictoStorys 30 and their Components and Sub-Components of the Instructional Presentations 28 are placed within the Referenced Page Cell Map 153 of the Architectural Blueprint 52 using the Production Populator 56. The Active Components of the Presentations 28 are located and renamed with encrypted coordinate file names associated with positions within a Referenced Page Map 114 and are stored in the Output Folder of the Data Store Resource 48.

As an example, the Introduction Presentation 25 may show a rapid synopsis of using the PictoKids Application Software 10 and the Explanation Presentation 27 may show how to use each of the features to create a PictoKids Adventure Presentation 100. The Explanation Presentation 27 may pictorially show a pointer device or mouse selecting controls and demonstrating the functions to create the PictoKids Adventure. The Navigation Presentation 29 may succinctly present navigating through the Theme Choice Montage Pages 20 and other features of the Pictorial Overlay Interface 70 of the PictoKids Application Software.

### Details of Module A: Theme Choice Montage Page

An important feature of Module A is the construction of the Theme Choice Montage Pages 20 that includes the Major Themes and Theme Sub-Topics for the User to choose from. In a first embodiment, a Theme Choice Montage Page is in a 3×3 format displaying pictures representing a theme. The Major Theme is of a broader scope and may encompass many topics, subjects and lessons that are then broken out into Theme Sub-Topics. In a first embodiment, a Major Theme Choice Montage Page may be developed for as an example the theme, “What do I Want to be When I Grow Up?” The Choice Generator 22 within Module A structures a series of pictures that are related to and encompass the Major Theme. In this example the picture may show people dressed in career garb and uniforms to pictorially represent the theme. The Choice Generator 22 formats pictures into the Major Theme Choice Montage Page 20. The pictures may represent careers, that in a first example may be of; 1. an Explorer; 2. a Super Hero; 3. a Newscaster, 4. an Astronaut, 5. a Scientist, 6. a Gardener, 7. a Policeman, or 8. a Doctor. For each Major Theme Choice Montage Page, a Theme Sub-Topic Choice Montage Pages is developed by the Choice Generator 22 through the selection from millions of pictures related to the Theme Sub-Topic. The Storyline Generator 24 will use the Major Theme and Theme Sub-Topics to structure the storyline of the PictoKids Adventure Presentation.

### Details of Module A: Storyline Generator

The Storyline Generator 24 is a key component of Module A of the present invention. The Storyline Generator 24 applies the KeyConcepts Query to the structured Scenes and Part Scenes for the storyline. Each Scene and Part Scene includes a directive for each scene to lead the User to populate the Architectural Blueprint with images that conform to the directive based on the applied KeyConcepts to the Scenes and Part Scenes. The selected image is then stylized into one or more Trans-Snips to be used in a Composite Image or PictoStory for the Scene and Part Scene. In a first embodiment, the structure of the storyline may have three Scenes with each Scene made up of five Part Scenes. The Storyline Generator 24 also formats the layout of a blank Architectural Blueprint 52 to match the storyline structure. A series of Image Selector Montage Pages 49 are developed for each of the Scenes and Part Scenes structured by the Storyline Generator 24. These images are selected for placement in the Montage Pages 49 based on their categorization and grouping in the Data Store Resource 48 using the Choice Generator 22.

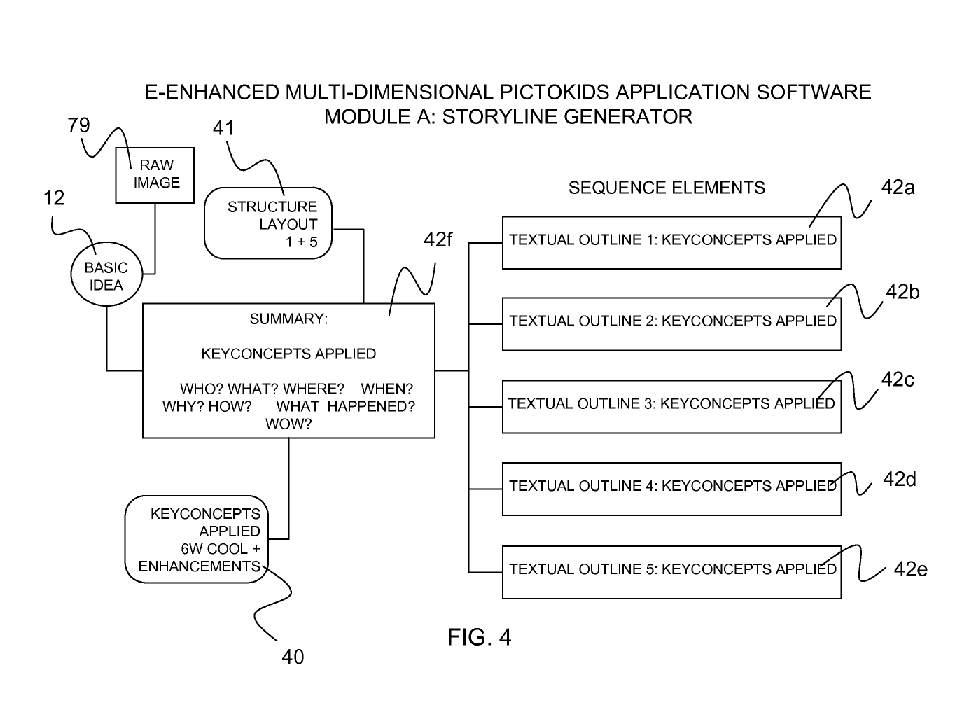

The Storyline Generator 24 includes features to apply the KeyConcepts Query 40 to the Scenes and Part Scenes that based on the Basic Idea 12 from the chosen Theme which may be a concept or picture extends and expands the Basic Idea into a textual representation. As an example the word Xmas or a picture of a Christmas tree may be structured into a Sequence of Elements 41 that determines how many Composite Images will be used in the PictoStory for a Scene or a Part Scene. For each Element a KeyConcepts Query is applied that may include a set of question such as the 6 W Cool questions “Where?, When?, Who?, How?, Why?, What Happens?” and “Wow?” In the example shown in FIG. 4, the Basic Idea 12 of the Theme and Theme Sub-Topic has been structured into Scenes and Part Scenes that may include a sequence of five Elements 41 with a Textual Outline indicated as 42a-42e developed and derived from the answers to these questions. Based upon the complexity of the Basic Idea 12 of the Major Theme and Theme Sub-Topic, any number of Scenes and Part Scenes with Elements 41 and Outlines 42 may be structured. A Summary Textual Outline 42f may also be developed from the gathered Textual Outlines 42. The Elements 41 and Textual Outlines 42 are used in a top-down approach to represent the Basic Idea 12 textually that is then used in Module B to develop a series of Composite Images 46 that are used in the PictoStorys 47 for each Scene and Part Scene structured within the storyline. The Sequence of Elements 41 and Textual Outlines 42 are located within the blank Architectural Blueprint 52.

### Details of Module A: Image Selector Montage Page

Also in Module A, a series of Image Selector Montage Pages 49 are developed based on the themes and storyline with a Montage Page developed for each Scene and Part Scene in the storyline. The Choice Generator 22 develops Image Selector Montage Page 49 from millions of images that are grouped and categorized based on storyline and structured Scenes and Part Scenes. The reduction of images used and the ease of displaying the images in Montage Pages provide for a User to quickly review and select an Image directed to a Scene and Part Scene and greatly reduces the number of images that must be downloaded by the PictoKids Software from a server to create the PictoKids Adventure Presentation. The Image Selector Montage Pages 49 are categorized and grouped based on, in a first embodiment, the 6 W Cool questions. A Character Montage Page 35 may also be developed in Module A for the User to select an image that represents themselves and others in the PictoKids Adventure. These images are developed based on the chosen Theme where for example, a Major Theme of outer space, may have a Character Image Selector Montage Page 35 that includes images of 1. An Explorer, 2. An Astronaut, 3. A Super Hero, 4. A Pilot, 5. A Scientist, 6. An Alien, 7. A Monster, and 8. A Doctor for the User to select from. Alternatively, the User may upload images of themselves that are added to the Character Image Selector Montage Page 35 by the Choice Generator 22. One or more poses by the User or images of the User in different clothing may be added to the Montage Page 35 to be selected as a particular character by the User. Additional images of friends of the User, famous actors or others may be uploaded and developed using the Choice Generator 22 with the Storyline Generator 24 sequentially ordering the Montage Pages 35 into the storyline.

### Details of Module B

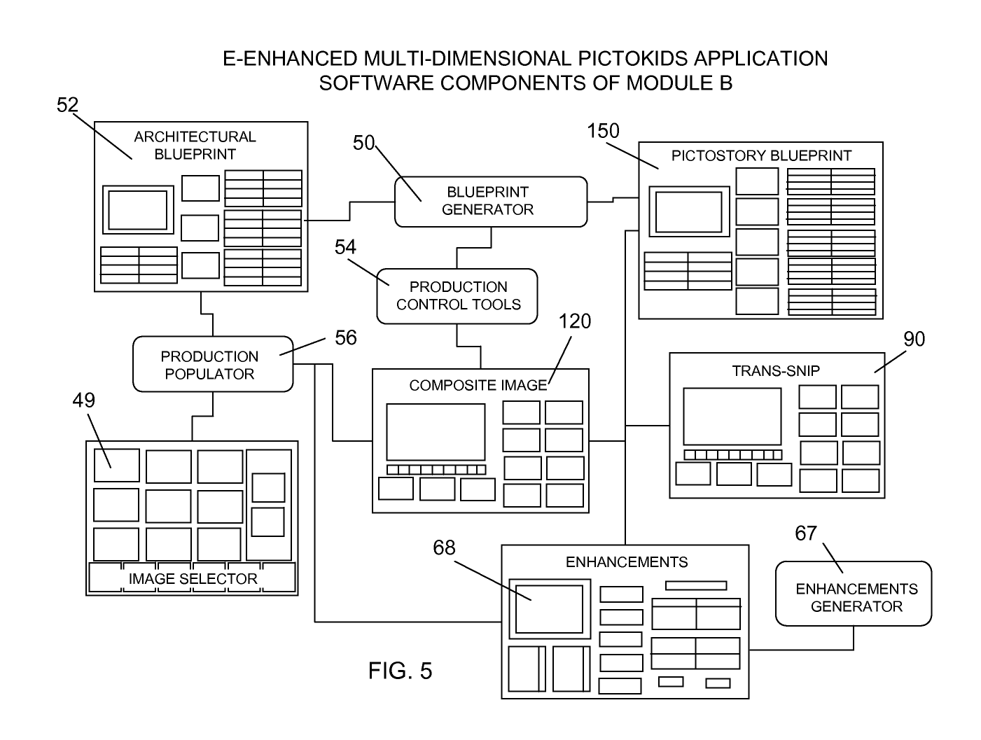

Module B as shown in FIG. 5 includes the Production Control Tools 54 of the Blueprint Generator 50 that is used to develop the PictoKids Adventure Presentation 100 within the Architectural Blueprint 52. The Architectural Blueprint 52 is formatted using the Referenced Page Map 114 to provide for navigation to each textual and pictorial element and their Components and Sub-Components. These Components and Sub-Components are stored within the Data Store Resource 48 using the encrypted Coordinate File Naming structure of the Referenced Page Map 114. The Architectural Blueprint 52 further provides for one or more Enhancements 68 to be associated with any PictoLayer 44 and for the rendering and realization that transforms the static PictoStorys 47 to dynamic Multi-Dimensional Presentations 100.

### Details of Module B: PictoStory Formation

As image selections are made by the User, PictoStorys 47 are developed behind the scenes and hidden from the User. The PictoLayer Generator 43 of the PictoKids Software 10 stylizes the selected images into pictorial representations that are related to the answers compiled from the Textual Outlines 42 of the Basic Idea 12 for each Scene or Part Scene. Through this stylization process, the selected images are formed into a set of Trans-Snips 45.The Trans-Snips 45 are then layered using a PictoComposite Generator 51 to create a set of Composite Images 46 that conform to the Basic Idea 12 of a Scene or Part Scene. The Architectural Blueprint 52 is populated using the Production Populator 56 with the Trans-Snips 45 and Composite Images 46 to form a PictoStory 47. Enhancements 68 using an Enhancements Generator 67 are applied to amplify, expand and enhance the PictoStory 47. The PictoStory 47 with its Composite Image 46, Trans-Snip 45 Components and Sub-Components, and Enhancements is structured within a PictoStory Blueprint 150 and is stored within the Data Store Resource 48. The Trans-Snips and other PictoLayers 44 may be printed on transparent sheets or on labels as cut-outs to form Composite Images 78.

### Details of Module B: PictoStory Trans-Snip Formation

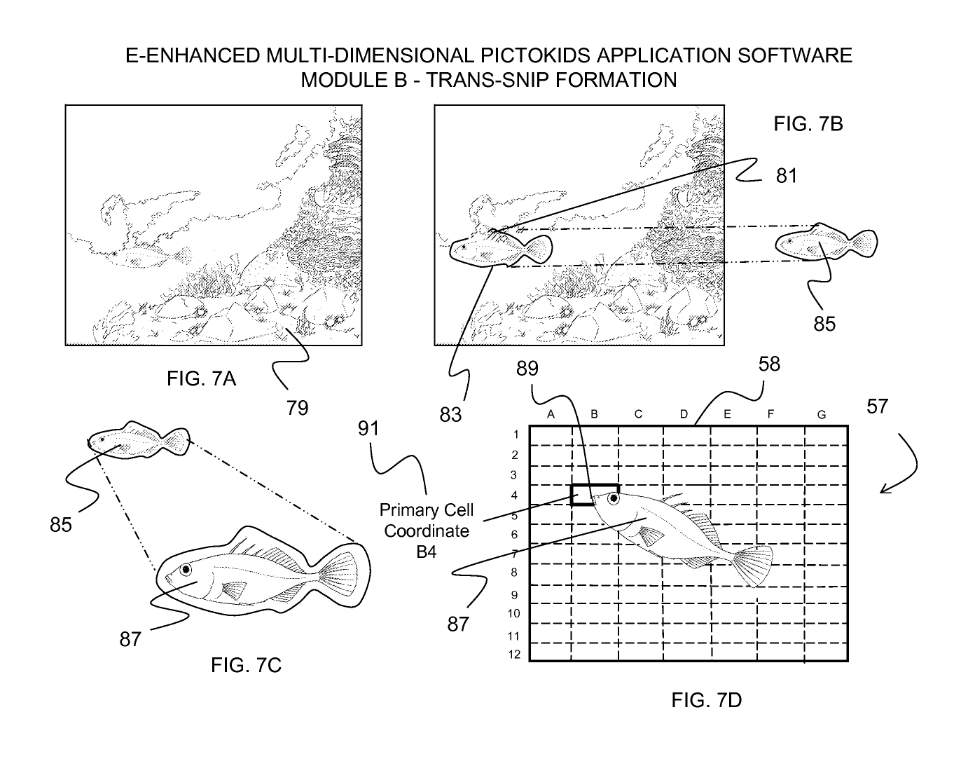

The PictoLayers 44 of the PictoStorys 47 are formed by processing a selected Raw Image 79 representing the Basic Idea 12 and Textual Outline 42. Importantly, the PictoKids Application Software 10 presents a limited number of images within the Image Selector Montage Pages 49 for the User to select from and then processes the selection into a pictorial representation that may include other images from the Data Store Resource 48 that are grouped and categorized to pictorially represent the Basic Ideas 12 of the Scene and Part Scenes. The selected images are processed from Raw Images 79 to Trans-Snips 45. A Trans-Snip 45 is formed, as shown in FIGS. 7A-7D, in a manner that is hidden from the User using the PictoLayer Generator 43.

As shown in FIG. 7B, a cutting tool 81 allows for a portion of the image 79 to be traced and cut out. The Raw Image 79 may be shape cropped into any shape by moving the cutting tool 81 over a portion of the image 79 or by selecting a preset shape such as an oval or rectangle using the PictoLayer Generator 43. In this example, the Raw Image 79 is a fish that is outlined 83 and cut out 85 in the shape of the fish. The shape cropped image 85 is resized 87 to any desired dimension within the horizontal and vertical limits of a Transparent Blank 57. In this example, the fish cut out 87 is enlarged and the white background around the image is removed. A white background is commonly created using a variety of snipping software tools for cropping an image. An exclusive feature of the PictoLayer Generator 43 is the removal of any white border providing for the Trans-Snips 45 to form a layered Composite Image 46. The fish image 87 is located on the Transparent Blank 57 that includes a Referenced Resolution Cell Map 58 to locate the image 87. The image 87 may further be oriented in any direction and be given a cell reference location by aligning for example its furthest left highest point 89 to indicate in this example, the coordinate position of B4 indicated as 91 within the Resolution Cell Map 58.

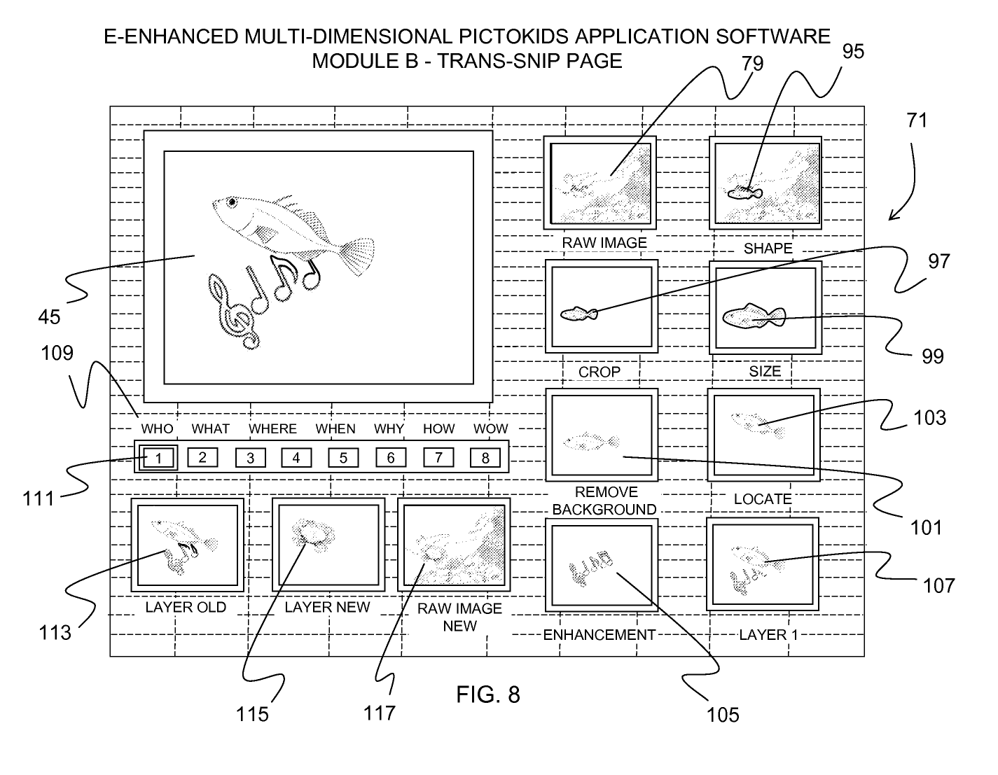

The process and sub-components of a Trans-Snip 87 including the Raw Image 79 is displayed within the Architectural Blueprint 52 on a layered Trans-Snip Page 71 as shown in FIG. 8. Each process step is displayed including the shaping of the image 95, the cropping of the image 97, the sizing of the image 99, the removal of the white background 101, locating the image on the Resolution Cell Map 103, associating the image with one or more Enhancements 105, and forming the Trans-Snip layer 107. Using the Production Controls 54 of the Blueprint Generator 50, the Trans-Snip Page 71 further provides KeyConcepts Indicators 109 and a Navigation Toolbar 111 to select a process step image. Layers may be replaced with alternatives that are accessible with the Current Component layer 113, the Alternative Component layer 115, and the Raw Image 117 of the Alternative Component 66.

### Details of Module B: PictoStory Composite Image Formation

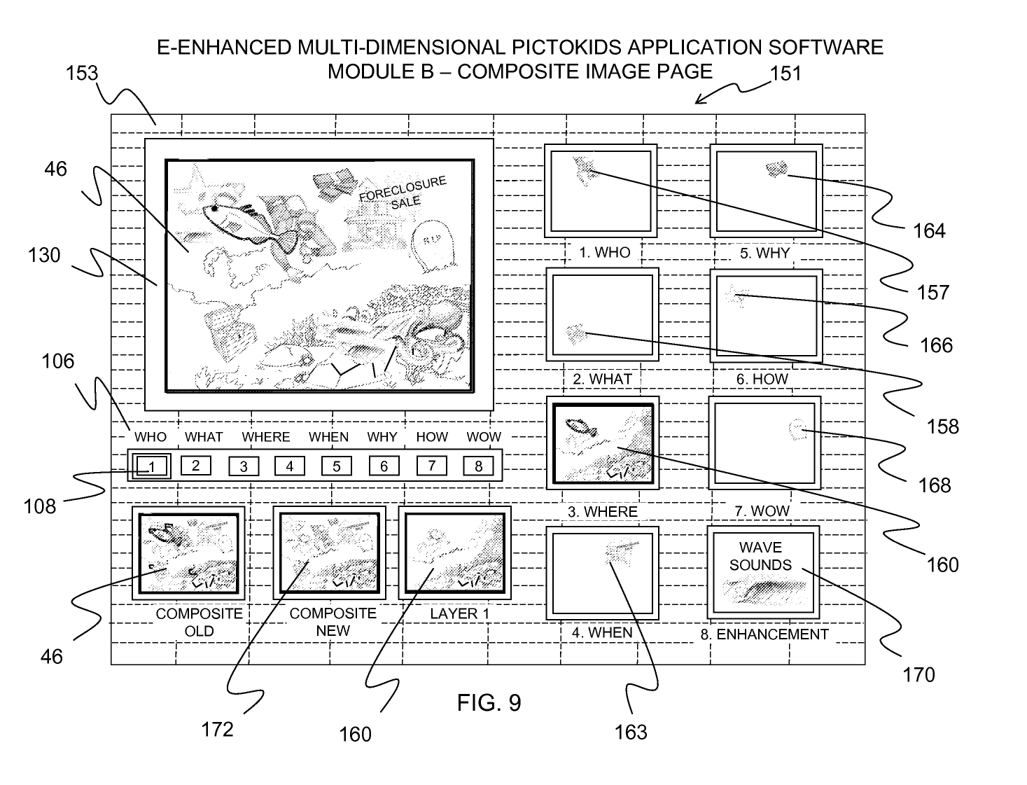

Using the PictoComposite Generator 51, a Composite Image 46 is formed from the layers of Trans-Snips 45. A Composite Image Page 151, as shown in FIG. 9, includes the layered Composite Image 46 and each of the layered Trans-Snip 45. In addition to the Resolution Cell Map 58, the Composite Image Page 151 provides a second coordinate system, a Referenced Page Cell Map 153 to navigate and modify the layered Trans-Snips 45 using the Production Tools 54 of the Blueprint Generator 50. Each of the Trans-Snips 45 pictorially represents the Sequence of Elements 41 of the Textual Outlines 42 and in this way the Composite Image 46 forms a pictorially representation of the Basic Idea 12 of a User selected image.

In this example, the Composite Image 46 is formed from Textual Outlines 42 related to a Basic Idea 12 of a Scene within a storyline based on a Major Theme related to under the sea, and Theme Sub-Topic of An Explorer. The images selected by the User for characters, locations and events of the Part Scenes are stylized into Trans-Snip 45 and are layered to form a Composite Image 46. In a first example, the Trans-Snip 45 include a sea diver 157 as one of the characters, a treasure chest 158, an underwater background 160, an event of a foreclosure on a home 163, and a bundle of cash 164 that may save the home from sale. The images selected from the Image Selector Montage Pages 49 also include the selection of a great white shark 163 and a gravestone 168 to conform to other directives for the Part Scenes within a Scene of the PictoKids Adventure. Enhancements 170 of the sound of waves crashing on the beach or sorrowful music dynamically transcend the somber moment to form the Composite Image 46 for a PictoStory 47 of the PictoKids Adventure Presentation 100.

The Composite Image Page 151 provides KeyConcepts Indicators 106 and a Navigation Toolbar 108 to select and modify a layered Component of the Composite Image 46. The Composite Image Page 151 further provides options for Alternative Components 172 based on the KeyConcepts Query 40. An Alternative Component 66 may replace an Interactive Component within a current Composite Image 46 and may be displayed in the Static Viewer 130 to determine if the Component should be replaced.

### Details of Module B: PictoStory Blueprint

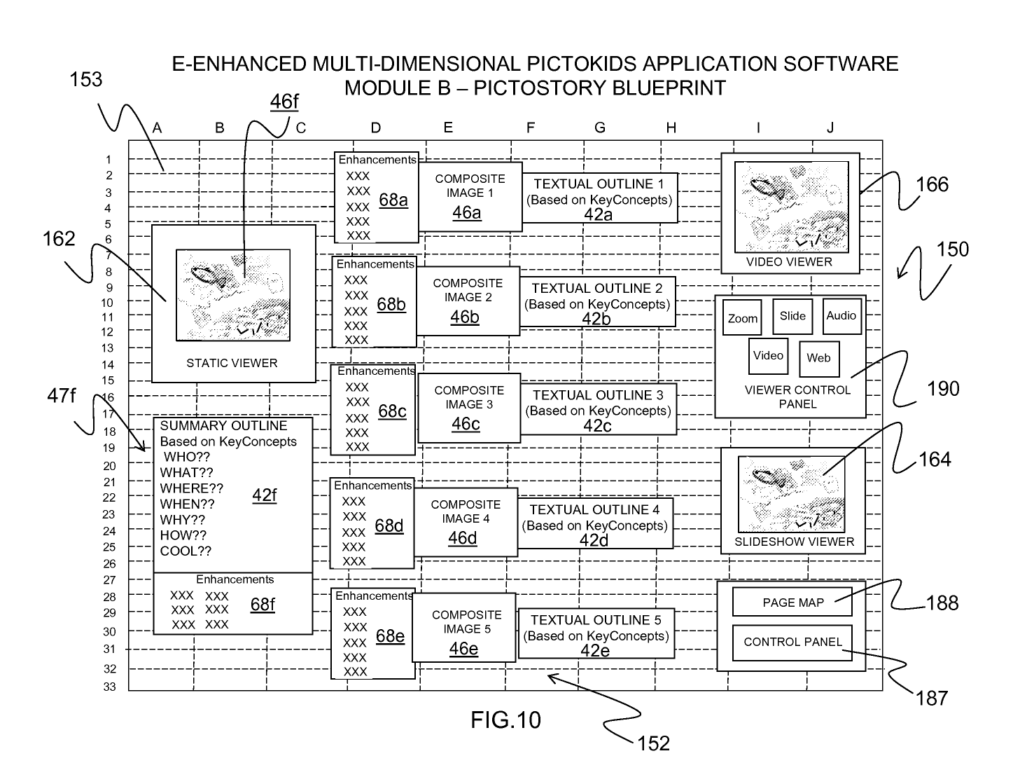

In creating a PictoStory 47 a series of Composite Images 46 with their Textual Outlines 42 and Enhancements 68 are located within the Architectural Blueprint 52 forming a PictoStory Blueprint or StoryBoard 150 shown in a first embodiment in FIG. 10. A PictoStory Summary 47f, is developed from all of the Composite Image Elements 152 that provides as an example a short two minute overview of the PictoStory 47. In this example, the Composite Image 46f of the PictoStory Summary 47f is located within a Static Viewer 162, a Slideshow Viewer 164 and a Video Viewer 166 for review and editing of its Components and Sub-Components including Trans-Snip layers 45 and Enhancements 68 associated with the Composite Image 46f. The other Composite Images 46a-46e structured by the Storyline Generator 24 are located in the Reference Page Cell Map 153 of the PictoStory Blueprint 150. The PictoStory Summary 47f of the combined Composite Images 46 is provided in this example below the Static Control Viewer 162 displaying the responses to each of the KeyConcepts Summary Query 40 using the 6 WCOOL questions as applied to Scenes and Part Scenes. Enhancements 68f for the Summary Page 47f and the Enhancements 68a-68e for the other Composite Images 46a-46e are accessible on the Referenced Page Cell Map 153 through access points that are represented as X's.

As shown, any Trans-Snip 45 or Composite Image 46 may have any number of Enhancements 68 to dynamically present the PictoStory 47. Access to the Enhancements 68 are designated within the Referenced Page Cell Map 153 as activation points, navigation buttons, hyperlinks or other markers that when selected run the Enhancement 68. Additionally, the Viewer Control Panel 190 provides tools to render and activate all or a portion of the E-Enhanced Multi-Dimensional PictoKids Adventure Presentation 100. The rendering of the Presentation 100 activates the associated Enhancements 68 to run any Subroutine, Software Application, URL, linkage, or other types of File Formats to add and amplify information available or associated with the PictoStory 47. Access to the Referenced Page Map 114 for navigation and to the Production Control Panel 187 is also provided.

### Module B: PictoKids Architectural Blueprint

The Architectural Blueprint 52 includes the Production Control Panel 187 that provides access to Actions, Hyperlinks, Macros, and conversions to HTML and Dynamic HTML (D-HTML). Actions that may be performed to review, edit and modify the Raw Images 79, Trans-Snips 45 and Enhancements 68 within the Composite Images 46. This may include ordering and displaying the PictoStorys 47 using the HTML and Dynamic HTML Code to activate and dynamically present the PictoKids Adventure Presentation 100. Within the Architectural Blueprint 52, the PictoLayers 44 may be edited, to add Enhancements such as narration or editing video Enhancements, or using the Viewer Control Panel 190 for editing and ordering a slideshow, recording audio, such as background music or narration or editing an animated enhancement.

Other control panels may provide access to Hyperlinks to link to page specific Dynamic HTML Code to a Component or Sub-Component, to Images, to Audio, to Video, to Slideshows, to a Voice Recorder and to Animation. A third control panel may provide access to Macros to go to a PictoStory Blueprint Page, to go to a specific Composite Image Page, or to copy or Print any PictoLayer by setting a print area and printing on a transparent sheet. A set of Trans-Snips 45 or other PictoLayers 44 may be printed on transparent sheets and then be arranged in varied orders to form a Collage or Decoupage Image that includes features and characters from the PictoKids Adventure Presentation 100. The removal of white background from the Trans-Snips 45 using the PictoLayer Generator 43 provides for the creation of colorful artistic creations from the pictorial elements of the PictoKids Adventure. Other control panels may provide access to display and edit Dynamic HTML Code for the Components and Sub-Components, for Audio Enhancements, for Video Enhancements, for Slideshows, for Voice Recording, and for Animation.

### Module B: Enhancements

Enhancements 68 are additional information or features associated with the PictoLayers 44 using an activation or access point corresponding to a Component or Sub-Component and associated with the Resolution Cell Map 58, the Referenced Cell Map 153, Referenced Page Map 114, a combination of cells, or any blank or populated Referenced Page Map Layer. Enhancements 68 by definition can be any further amplification, pictorial expansion or transition to a Sub-routine or indeed totally different URL or a fully interactive application that are activated and referenced by selecting a button, clicking a mouse, touching a screen or using any other operational control at the appropriate cell mapped reference points on a Trans-Snip 45, Composite Image 46, or PictoStory 47 using the Production Controls 52 of the Blueprint Generator 50. The Enhancement 68 may be in numerous forms, including inter alia: Text, Narration, Music, Song, Slides, Animation, Count, etc. with interactive tools for navigation and data entry where required. This additional enhanced information may be features that add dimension and depth to the KeyConcepts 40 of the Basic Idea 12.

### Module B: Referenced Page Map and Referenced Page Cell Map

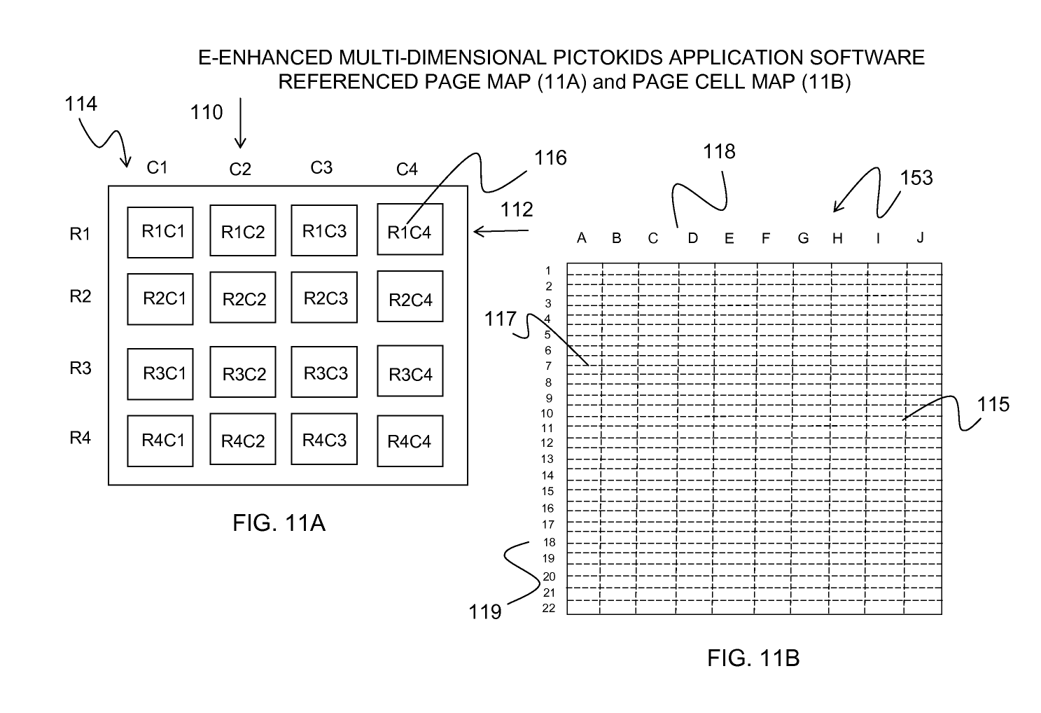

Using the Storyline Generator 22 and Blueprint Generator 50, a blank Architectural Blueprint 52 is formatted with a Blank Referenced Page Map 114 and Blank Referenced Page Cell Map 153 coordinate system as shown in FIGS. 11A and 11B based upon the number of PictoStorys 47. The Blank Referenced Page Map 114 structures a series of columns 110 and rows 112 that provide navigation to all Pages 116. Both the Page Map 114 and Page Cell Map 153 coordinate system or grid may be “Display Page Driven” in a spreadsheet-like format having an alphanumeric X-Coordinate 118 and a numerical Y-Coordinate 119 with a series of gridlines 117 that form a series of cells 115. The gridlines are dotted to show the transparency of the Blank Architectural Blueprint 52.

A Coordinate Data File Naming Structure using randomized, scrambled and/or encrypted file names based upon coordinates of the Referenced Cell Map 153 is developed within an active Output File Folder and stored within the Data Store Resource 48. In this way, the PictoStorys 47, their PictoLayers 44, their Components and Sub-components that populate the Blank Architectural Blueprint 52 are given encrypted files names corresponding to locations in the formatted Referenced Page Map 114 with each file name corresponding to an active location within the grid. The PictoStorys 47 with their PictoLayers 44, Textual Outlines 42 and Enhancements 68 are located within the Referenced Cell Map 153 by designating specific, encrypted grid coordinate file names thereby providing for navigation to any Component or Sub-Component within the Architectural Blueprint 52.

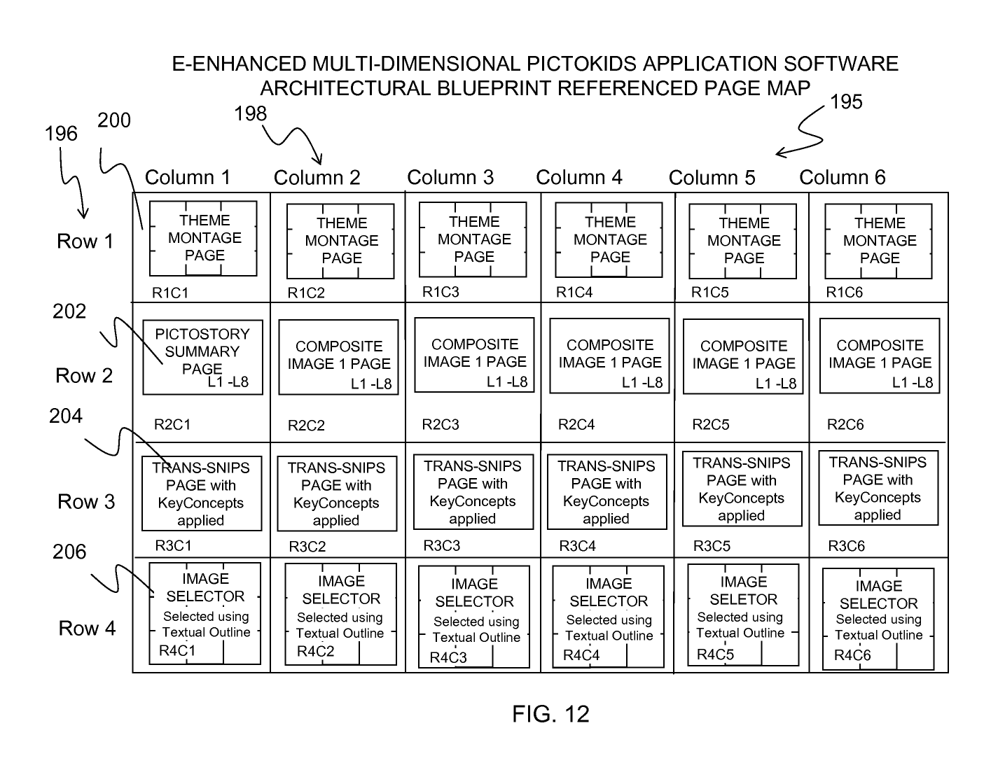

Each PictoLayer 44 has an X, Y and Z Resolution Cell Map Coordinate within each the Trans-Snip 45 and an X, Y and Z coordinate within each Referenced Page Cell Map 153 of the layered Composite Image 46. This structure further provides for Enhancements 68 to be linked at any Multi-Dimensional level; to any PictoLayer 44 such as any Trans-Snip 45, Composite Image 46 or to a group of Composite Images within a PictoStory Blueprint 150. As shown in FIG. 12, by zooming out on the Referenced Page Map 114 the Theme Choice Montage Pages and their Component and Sub-Components are accessible in the Row 1 indicated as 200; the PictoStorys and their Composite Images are available in Row 2 indicated as 202 the Trans-Snips for the PictoStorys are available in Row 3 indicated as 204 and the Image Selector Montage Pages are available in Row 4 indicated as 206 and in this way navigation in the Reference Page Map 114 is performed not by scrolling but by selecting any Component or Sub-Component or zooming in and out of the Architectural Blueprint 52. The navigation provides access to these Components to activate, review, link and modify any PictoLayer 44 or Enhancement 68 to expand and amplify the Multi-Dimensional PictoKids Presentation 100. Any number of pages having other Components may be located within the Referenced Page Map 114.

### Module B: Alternative E-Enhanced Multi-Dimensional PictoKids Presentations

Using the Architectural Blueprint 52 and Production Control Tools 54, the PictoStorys 47 are dynamically transformed with Enhancements 68 and production effects that are then assembled to produce the film like E-Enhanced Multi-Dimensional PictoKids Presentation 100. This Sequence of PictoStorys 47 may create a time or action sequence or a series of events that present the story developed by the Storyline Generator 24. The Enhancements 68 may be interactive for a user presenting games and challenges that intrigue, captivate and entertain the User. The PictoKids Adventure may have multiple characters and be created from multiple PictoStorys. The PictoKids Adventure may also be further transformed by replacing any Interchangeable PictoLayer 44 with an Alternative PictoLayer 66 to change characters, settings, events, actions, and outcomes in the PictoKids Adventure Presentation 100.

Within a PictoStory 47, the Alternative PictoLayer 66 is selected from the Image Selector Montage Page 49 that accesses a Variable File Folder in the Data Store Resource 48 and replaces the Interchangeable Component by renaming the Alternative PictoLayer 66 with the encrypted file name that corresponds to the location of the Interchangeable PictoLayer in the Referenced Page Map 114 and Referenced Page Cell Map 153 of the PictoStory Blueprint 150 and by saving the Alternative PictoLayer 66 in the Output Folder in the Data Store Resource 48. Using the Production Controls 54 of the Blueprint Generator 50 the Alternative PictoLayer 66 is rendered and realized within the Output Folder to be viewed within the film-like E-Enhanced Multi-Dimensional PictoKids Adventure Presentation 100.

### Details of Module C: Pictorial Overlay Interface

In Module C, the Pictorial Overlay Interface 70 provides access and control to the User viewable features in the PictoKids Software Application. In a first embodiment, access to the PictoKids Software is first controlled through a retail purchase to obtain a quantity of minutes or points. Entering an access or transfer code stores a number of minutes or points (i.e. PictoCash as described in U.S. Patent Application No. 61/763,749) allows a User to access the PictoKids Application Software and use the PictoKids Software based on the amount of PictoCash available. A counter within the PictoKids Software tracks the usage and amount of available PictoCash the User expends while accessing the PictoKids Software. Upon entering and acceptance of the transfer code, the PictoKids Software presents to the User the opening screen which includes access to the Introduction, Explanation and Navigation Presentations that provide a short in-depth synopsis of how to play, compete and win rewards by creating a PictoKids Adventure Presentation 100.

Other controls of the Pictorial Overlay Interface (POI) 70 present options for the User to choose a Major Theme and the Theme Sub-Topics from the Theme Choice Montage Pages 20 for the PictoKids Adventure Presentation 100. Importantly, all control features are presented and available on each screen without the use of pull down menus and each screen is formatted and sized to fit and be compatible with cellular phones, smart phones, IPods, IPhones, IPads, tablets, laptops, personal computers and any other electronic communications device. In an embodiment to further protect and restrict access to only authorized Users, the User while accessing the PictoKids Application Software must provide further verification through the acknowledgement of a presented pictorial element that requires the completion of a PictoIdentity or PictoPuzzle as described in U.S. Patent Application 61/763,749. Failure to properly enter the code will result in the PictoKids Software closing and becoming inaccessible. The PictoKids Software will also close upon the depletion of minutes or PictoCash points and will not be restored until additional PictoCash is transferred to an external server entity using a purchased access or transfer code to obtain more minutes or PictoCash points. The external server entity may further provide for competitive scoring and rewards that will restore depleted PictoCash reserves by having the User enter and win acknowledgement and rewards for their PictoKids creation.

The POI 70 also provides all of the controls for the User to access and choose the Major Theme and Theme Sub-Topic and select from hundreds of pictures the settings, time, characters (including the User as the PictoKids Character), the things that happen, how things happen and the outcomes for the Scenes and Part Scenes of the PictoKids Adventure Presentation. These selections are dynamically transformed within the Architectural Blueprint 52 using the Storyline Generator 24 and features of the Blueprint Generator 50 to create the unique User designed PictoKids Adventure Presentation 100.

### Details of Module C: The PictoKids Production Presenter

The components of Module C also include access to the Production Presenter 72 to view the PictoKids Adventure Presentation 100 and printer controls to print PictoLayer Cutouts 77 from the Presentation 100. Importantly, only a subset of features of the Production Control Tools 54 of the Blueprint Generator 50 is accessible to the User to make limited changes to the final rendered PictoKids Adventure Presentation 100. The Production Presenter 72 provides control buttons to view the Introduction Presentation 25, Explanation Presentation 27 and Navigation Presentation 29. The Presentations 28 include an overview of the features of the PictoKids Application Software 10 and present instruction on how to use and navigate through those features. Other controls provide for the User to Login, access Help, preview the PictoKids Adventure Presentation 100, play the Presentation 100, select and Print 76 any PictoLayer 44 from the Presentation 100.

Using the Production Presenter Tools 72, a User may scan to any portion of the Presentation 100 and select any single PictoLayer 44 or group of PictoLayers 44 to print to create artistic Collage Displays 78 or Cutouts 77 of characters or things in the Presentation 100. The Cutouts 77 may be printed on paper, transparent sheets, sticker labels, pre-cut Avery labels, fabric or other material that may be adhered to a fabric fastener such as Velcro. The cutouts 77 may be mounted and displayed on a Display Board 75 that includes digital speakers 73 that may be networked through a LAN or wireless connection, and that may receive the sound, narration and sound effects from the PictoKids Adventure Presentation 100, or provide background music or other sounds for the User to listen to while creating their Collage 78 or pastiche artistic creations from the PictoLayer Cutouts 77. The Display Board may be assembled from PictoKids components or building blocks to change the size and shape of the Display Board to suit artistic creations of different size and complexity. In an embodiment, the Display Board screen may be enlarged as needed for a larger work area to present the creation or be mounted or tilted to provide for accessibility for the User.

### Details of Module C: Creating the PictoKids Adventure Presentation

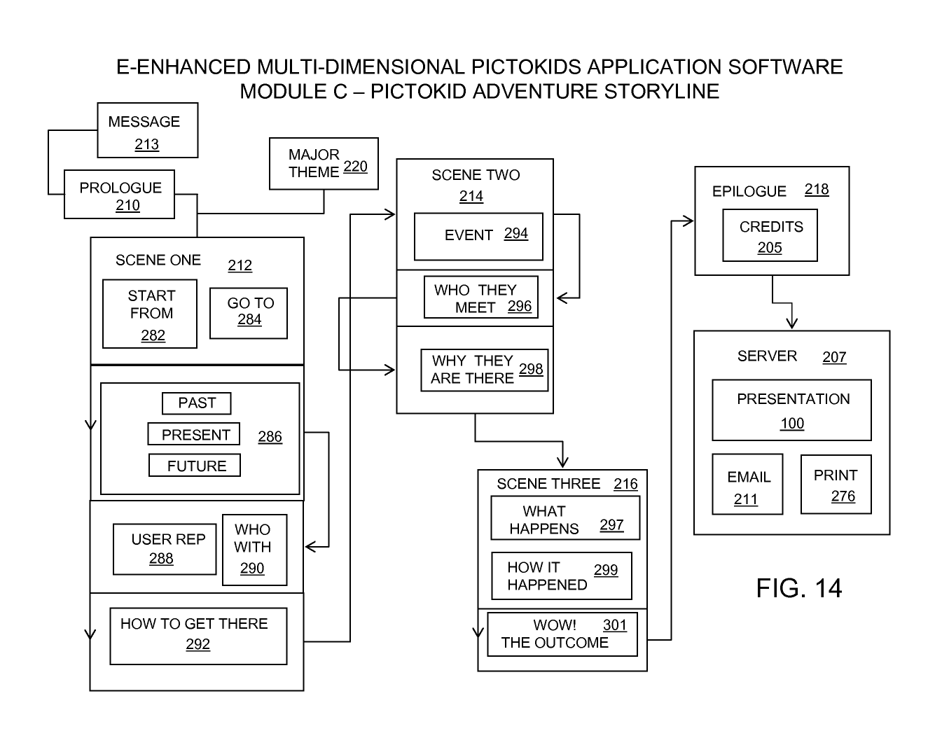

Module C includes the layout of the storyline for the PictoKids Adventure Presentation 100 that in a first embodiment includes a Prologue 210, a First Scene 2 12, a Second Scene 214 and a Third Scene 216 and an Epilogue 218 as shown in FIG. 14. The PictoKids Adventure Presentation begins with a Prologue 210 that includes a title for the presentation, a title page with an image selected by the User or developed from the PictoStorys 47 by the Storyline Generator 24 for the Presentation 100, and an introductory message 213 that may be recorded by the User. The Scenes and Part Scenes of the PictoKids Adventure Presentation 100 are presented in the Image Selector Montage Pages 49 to lead and direct the User to select the sequence of images that must be made to create the PictoKids Adventure Presentation 100.

In this example, in creating Scene 1 212, the User may first choose a Major Theme from a Theme Choice Montage Page 220 that presents pictures for an adventure entitled “______ (Enter User's Name) Takes a Trip”. The User is then presented with a series of pictures of possible destinations for a trip and as a Theme Sub-Topic chooses a picture representing what type of character the User will be on the trip. The Image Selector Montage Pages are then structured and presented in the format of the Scenes and Part Scenes with a first Page directing the User to select where the PictoKids Adventure will Start From 282, a second Page directs the User to select an image of where the characters will Go To 284. The next Image Selector Montage Page within the formatted sequence directs the User to select when the PictoKids Adventure takes place whether it happens in the Past, Present or Future 286. The User is then directed to select from a series of the Character Image Selector Montage Pages 35, a User Character 288 from the images that will represent the User in the PictoKids Adventure and a Companion Character 290 that goes with the User Character 288 on the PictoKids Adventure. The PictoKids Application Software 10 provides features for the User to upload images of themselves and their friends to be incorporated and be used, so they may select these images or upload an image of favorite actor to select each of these images to become characters within the PictoKids Adventure Presentation 100. The final requirement for Scene 1 212 is the direction to the User to select How They Get There 292 meaning to the destination location in the PictoKids Adventure.

In Scene 2 indicated as 214, the User is directed by the PictoKids Application Software to select an image that represents the context of where they are going to, such as an Event 294 or location that provides the significance of the journey in the Adventure. The User is then directed to select from the Character Image Selector Montage Page 35 an image that represents one or more characters 296 that the User meets at the event 294. In the final Part Scene in Scene 2 214 the User is directed to select an image representing the reason Why 298 the Characters 288 and 290 have come to the event.

In Scene 3 indicated as 216, the Image Selector Montage Page 49 displays a series of images related to the selections made by the User in Scenes 1 and 2 and that conform to the Scenes and Part Scenes formatted by the Storyline Generator. The User is directed to select an image that represents What Happens 236. The User is then directed to select an image from the Image Selector Montage Page 49 that shows How the Action Happened 201, and then images that represent the Wow! 203; meaning the result or outcome of what happens in the PictoKids Adventure. The User selects from these Image Selector Montage Pages 49 the what, how and outcome of what happens in the PictoKids Adventure. In the Epilogue 218, the User may provide a final message and may select an image for the finale page. They may also enter their name to be displayed in the Credits 205. The User's selections are then downloaded to a server 207 using an internet connection 13 and are stylized, sequenced and enhanced into a series of PictoStorys 47 to create the PictoKids Adventure Presentation 100. Using the Production Presenter Tools 72 of Module C, the Presentation is available to the User for viewing or emailing 211 or printing 276 any portion of the Presentation 100.

### Details of Module C: Choice Montage Pages

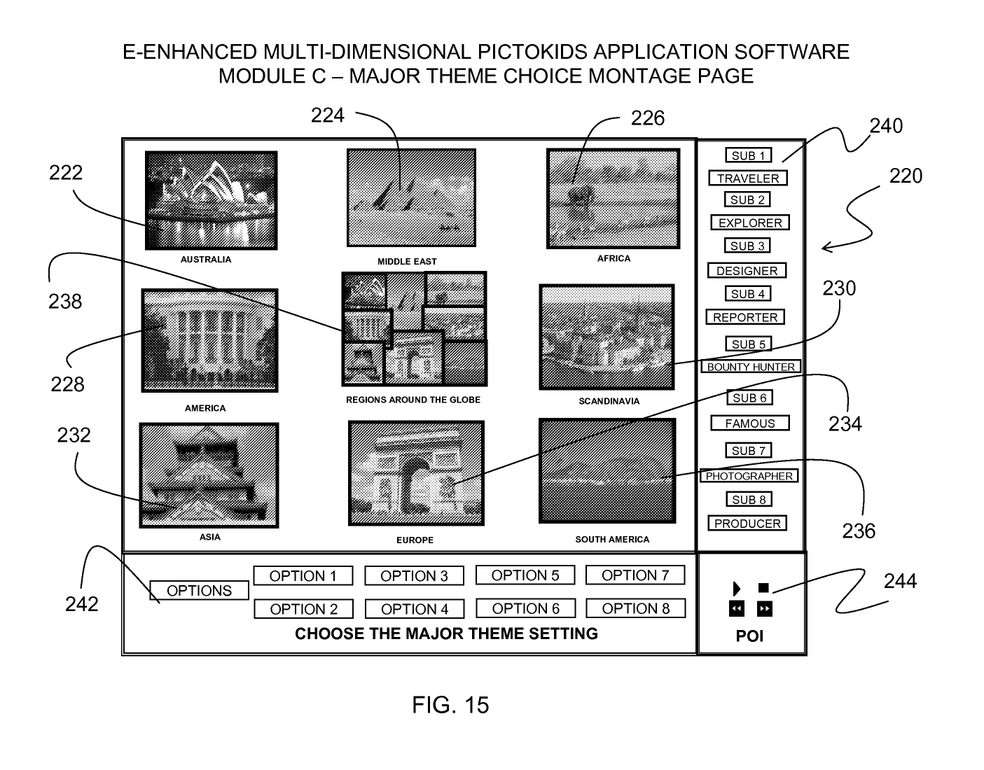

The software features of Module C provide for the User to choose from a series of pictures representing the Themes from the Theme Choice Montage Pages. The Theme Choice Montage Pages are developed in Module A from indexed and categorized pictures that are stored in the Data Store Resource 48. In a first embodiment, the Major Theme Choice Montage Page 220, as shown in FIG. 15, is in a 3×3 format displaying eight pictures that represent settings for the User to choose from to determine where the PictoKids Adventure will take place. In this example, regions around the globe are shown such as Australia 222, Middle East 224, Africa 226, USA 228, Scandinavia 230, Asia 232, Europe 234, and South America 236. The User makes a choice of the setting for the PictoKids Adventure by touching or indicating the chosen picture by choosing from the Choice Option Buttons 242 using a mouse, keypad, phone keypad, touch screen or other input. The center picture 238 shows the User's choice of Europe for the Major Theme. Access to Option Buttons 240 for the User to pick the type of character they will be on the adventure must also be chosen for the Theme Sub-Topic. Access to the Pictorial Overlay Interface (POI) 244 is also available.

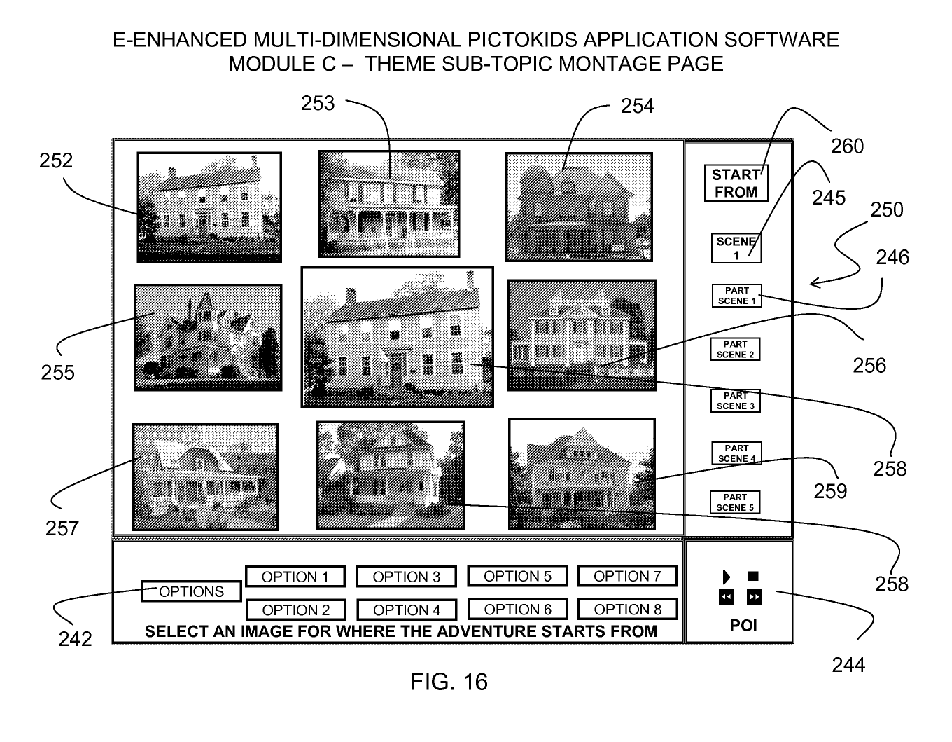

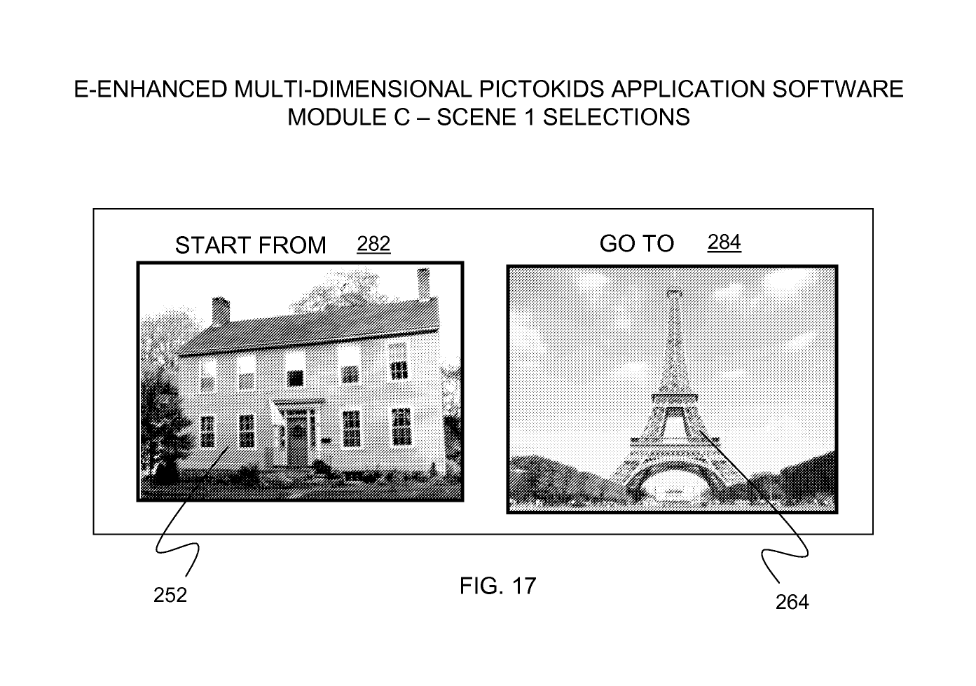

The Major Theme Choice Montage Page provides a broader scope of options that when chosen opens a narrower range of options that are displayed in subsequent Theme Sub-Topic Choice Montage Pages. These choices are structured behind the scenes using the Storyline Generator 24 into the Scenes and Part Scenes that will make up PictoKids Adventure Presentation 100 and are used to develop the Image Selector Montage Pages 49 that the User will select from to create the Presentation 100. As shown for example in FIG. 16 as a first embodiment, the User is directed to make a first selection of where the PictoKids Adventure will Start From 282. The Image Selector Montage Page 250 shows a number of different images of houses for the User to select for where the adventure starts from. The houses are indicated as house 252-259. The Image Selector Montage Pages 250 includes a Scene Title Indicator 260, the Scene Indicator 245 and the Part Scene Indicator 246 and Option Choice Buttons 242 for the User to select where the adventure will Start From 282. Access to the Pictorial Overlay Interface (POI) 244 is also available. As an example, selecting the House image 252, for the “Start From” 282 opens another Image Selector Montage Page 49 that will direct the User to select from the displayed images of places where the PictoKids Adventure will go. The Major Theme in this example is Europe and as shown in FIG. 17, an image representing Paris 264 is selected by the User.

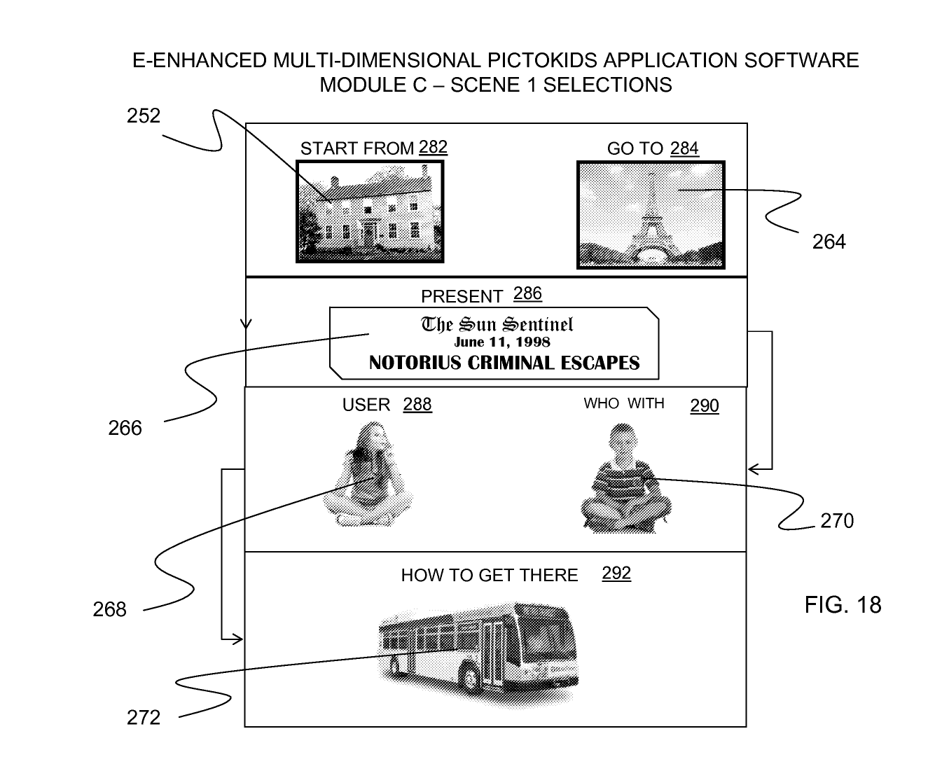

For the additional requirements to complete the information needed by the PictoKids Software to create the PictoKids Adventure Presentation 100, the User is directed to select an image that represents when the PictoKids Adventure will take place. The images within the Image Selector Montage Pages 49 represent the past, present and future and the User is directed to select an image displaying a current Newspaper clipping 266 as shown in FIG. 18. Based on these selections a series of Character Image Selector Montage Pages 35 are displayed that present a series of images that direct the User to select the character they would like to represent themselves in the PictoKids Adventure. If the User selects an uploaded image of themselves the image is displayed within the Character Image Selector Page 35 to be used in the PictoKids Adventure. The Character Image Selector Pages 35 are then presented to direct the User to select who they would like to have accompany them on the PictoKids Adventure. The displayed images are related to various characters, occupations and roles that relate to the type of character chosen as the Theme Sub-Topic. For example, for the Major Theme choice of Europe, and the Theme Sub-Topic choice had options related to characters that travel such as 1. A Traveler, 2. An Explorer, 3. A Designer, 4. A Reporter, 5. A Bounty Hunter, 6. A Famous Person, 7. A Photographer, and 8. A Producer.

In this example, the type of character chosen as the Theme Sub-Topic is a photographer so the Character Image Selector Montage Page 35 provides images of photographers for the User to select. The eight images within the display may be of men, women or children and may also include images that are uploaded by the User of themselves or others to be in the PictoKids Adventure. By selecting the PictoKids Characters, the Architectural Blueprint 54 is populated with the image representing the character associated with the User 268 and with the second image representing the character selected as the Companion Character 270. In FIG. 18, the User Character 268 and Companion Character 270 images for example are shown. Scene 1 Is completed with a display of an Image Selector Montage Page that directs the User to, in the final selection, select How the Characters 268 and 270 travel from the Start From location 282 to the Go To location 284 and in this example, the User selects a mode of transportation of a Bus 272 as shown in FIG. 18. Importantly as each selection is made the Choice Generator 22 structures a second series of Image Selector Montage Pages 49 for the next selection that is based on the previously selected images and fulfills the requirements for the types of images needed in the Scenes and Part Scenes of the storyline.

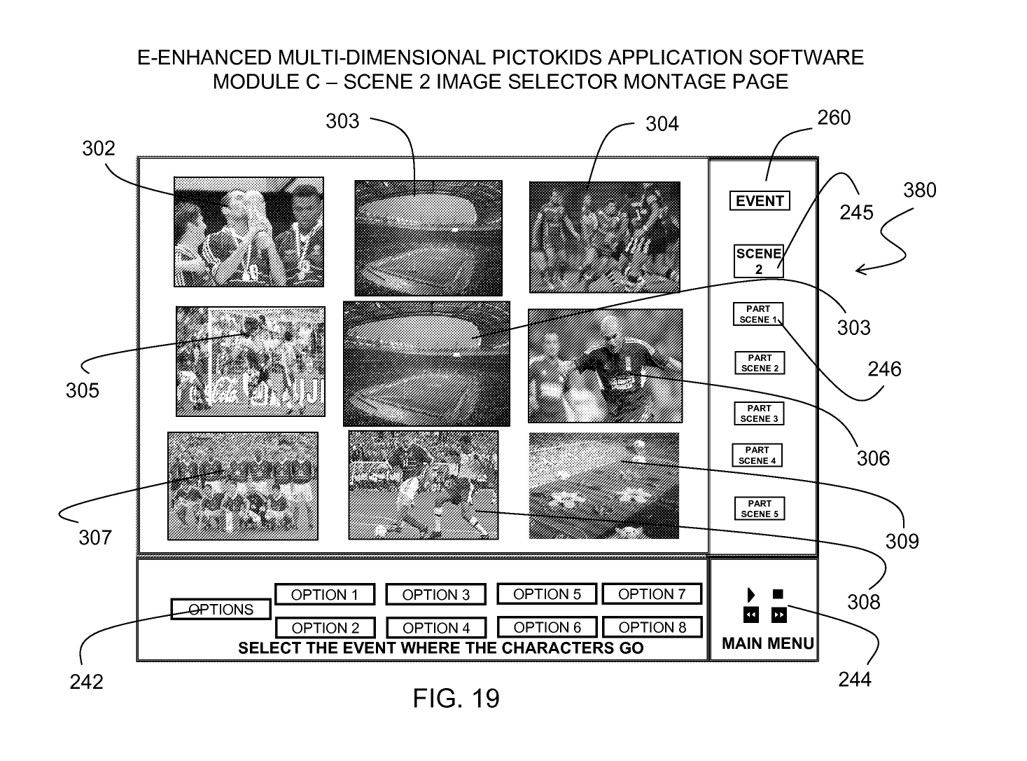

For any selection the User may by using the control buttons select a different image for a character, setting or outcome at any time while creating the PictoKids Adventure. In this example for Scene 2, a World Cup soccer game is selected by the User as the Event 294 that is attended by the User 268 and Companion Character 270. Hidden to the User, the selections are through a stylization process used to create a PictoStory 47 that pictorially represents the World Cup in France. Using the PictoLayer Generator 43, the User selected Raw Image 79 of a stadium 303 as shown in FIG. 19 from the images 302-309, is used to create one or more Trans-Snips 45 that are used in a Composite Image 46 to represent the World Cup in a PictoStory 47. The Composite Image 46 becomes a Part Scene of Scene 2 in the PictoKids Adventure Presentation 100.

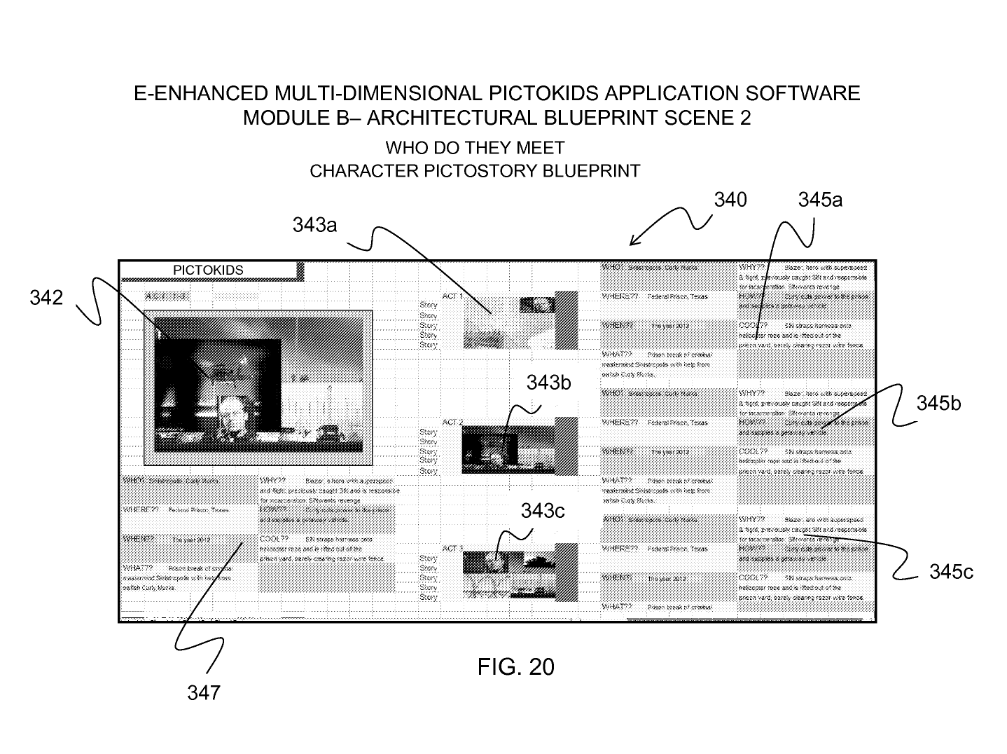

The User is then directed to select as a Part Scene in Scene 2 an image representing a Character 296 that the User 268 and Companion 270 encounter at the Event 294. From the selection by the User, behind the scenes and hidden from the User, the Blueprint Generator 50 creates a Character PictoStory 340 that pictorially represents the selected image of a character the User 268 and Companion 270 will encounter. The Character PictoStory Blueprint Page 340 is placed within the Architectural Blueprint 52 as shown in FIG. 20 and is developed in Module B that may provide comprehensive information and background about the character based on the application of the KeyConcepts by the Storyline Generator to the Scenes and Part Scenes as shown pictorially in the Composite Image 342. The Character PictoStory Blueprint 340 for the Encountered Character 296 in this example is a criminal mastermind that escaped from a prison in Texas. The Blueprint 340 may provide a series of Composite Images 343a-343c and Textual Outlines 345a-345c and a Summary 347 about the Character 296. Any amount of information or number of PictoStorys may be developed by the PictoKids Application Software using the Blueprint Generator 50 to provide depth and texture to any character, setting, action or outcome with numerous Enhancements 68 available to animate and bring the character to life, or features of the story such as by using PictoLayers of famous actors, or by using animation or audio recordings to give a voice to the character.

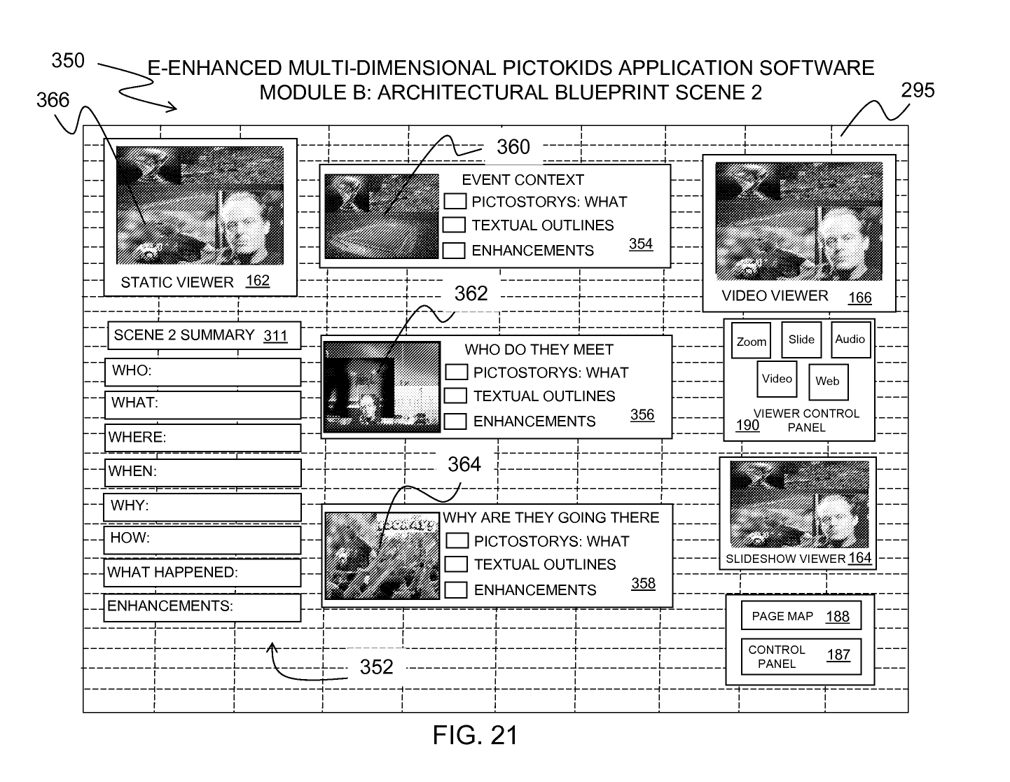

The Image Selector Montage Pages 49 for the Scenes and Part Scenes presenting images direct the User to select the required elements that are structured into and must be included to create the PictoKids Adventure Presentation. In this example, the next selection directs the User to select images for the Why 298 the User 268 and Companion 270 are at the Event 294. In this example, the User 268 and Companion 270 are traveling to Paris 264 to see and take pictures of their favorite soccer player in the World Cup Match. From the User's selections, as shown in FIG. 21, a Scene 2 Summary Page 350 including the Scene 2 Summary Textual Outline 352 and the Part Scene PictoStorys 354, 356, and 358 is developed behind the scenes and hidden from the User. The Composite Images 360, 362 and 364 for each PictoStory are also shown. The Scene 2 Summary 350 is derived from the Textual Outlines and PictoStorys of the Part Scenes within Scene 2 and provides a short perhaps two minute overview presentation of the Scene. The Summary Composite Image 366 is shown in the viewers.

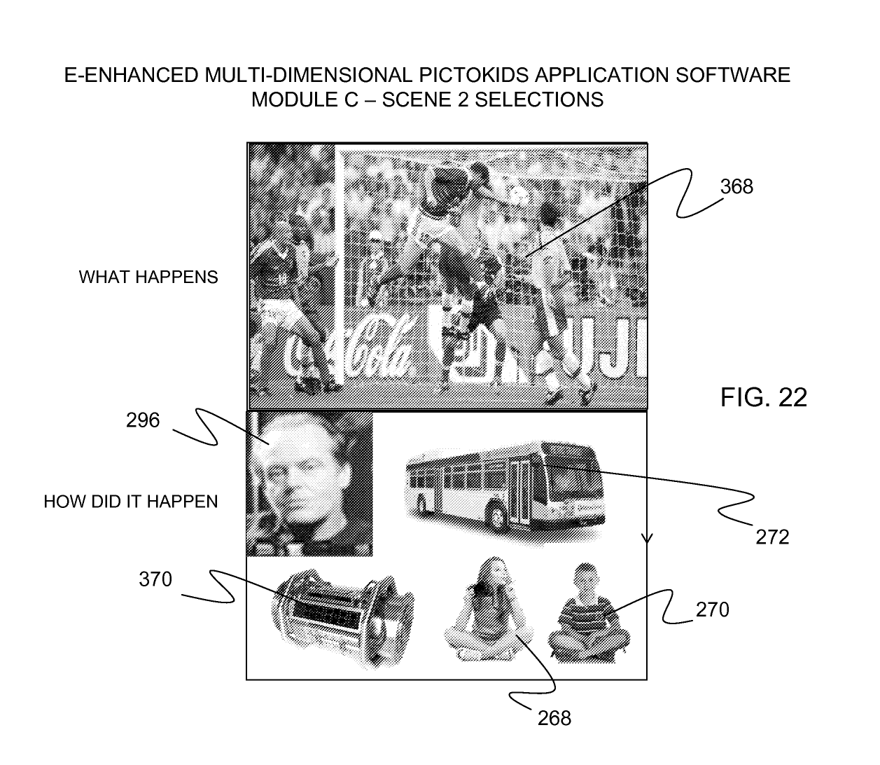

In Scene 3, Image Selector Montage Pages 49 are displayed that present actions and possible outcomes from the events and encounters of Scene 2. A series of images are presented that represent actions that direct the User to select the effect of What Happens 297 to the User 268, the Companion 270 or the Encountered Character 296. In this example as shown in FIG. 22, the User selects an image of their favorite soccer player 368 who will be at the soccer game they are attending. For the next image the Uses selects a bomb 370 that represents How it happens 299. The Character 296 they encounter is an escaped criminal from Texas who puts a bomb 370 on the bus 272 that the User 268 and Companion 270 are traveling on in order to have the bus blow up right outside the stadium 298 at the World Cup Soccer Game. In this example, the Image Selector Montage Pages 49 have been made and are related to Scenes and Part Scenes structured and formatted using the Storyline Generator 24. The PictoLayer Generator 43 then stylizes these selections into a sequence of selected images into PictoStorys 47 that dynamically and emotively presents the bomb 370 being placed on the bus 272 to blow up right at the stadium as the What Happens in the PictoKids Adventure Presentation 100.

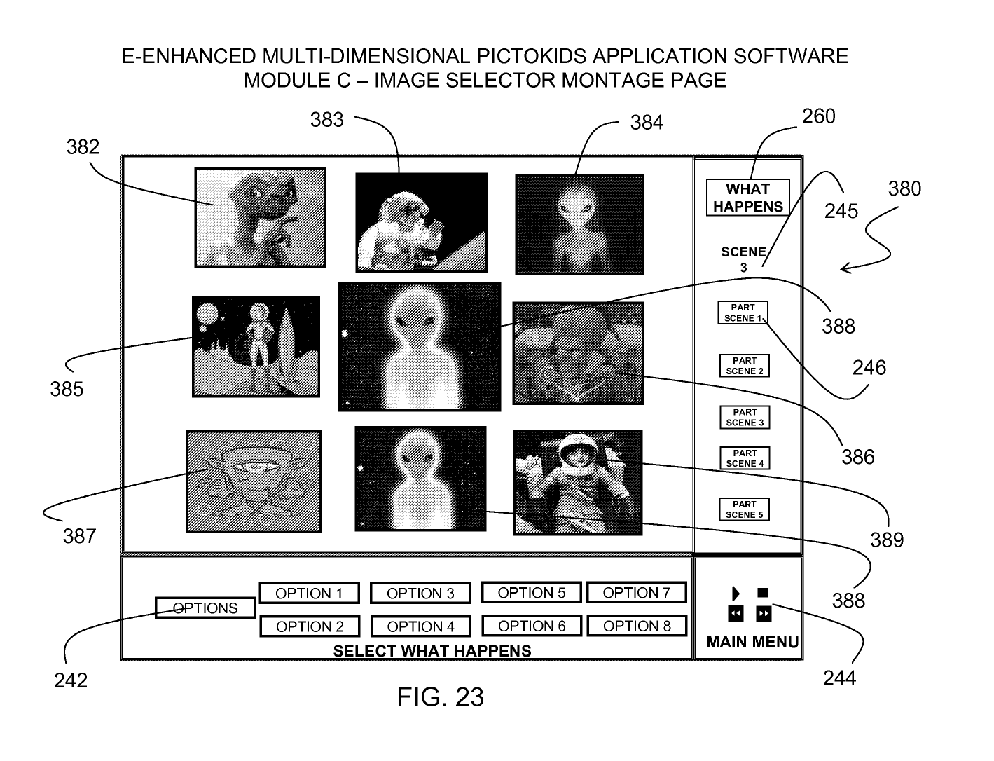

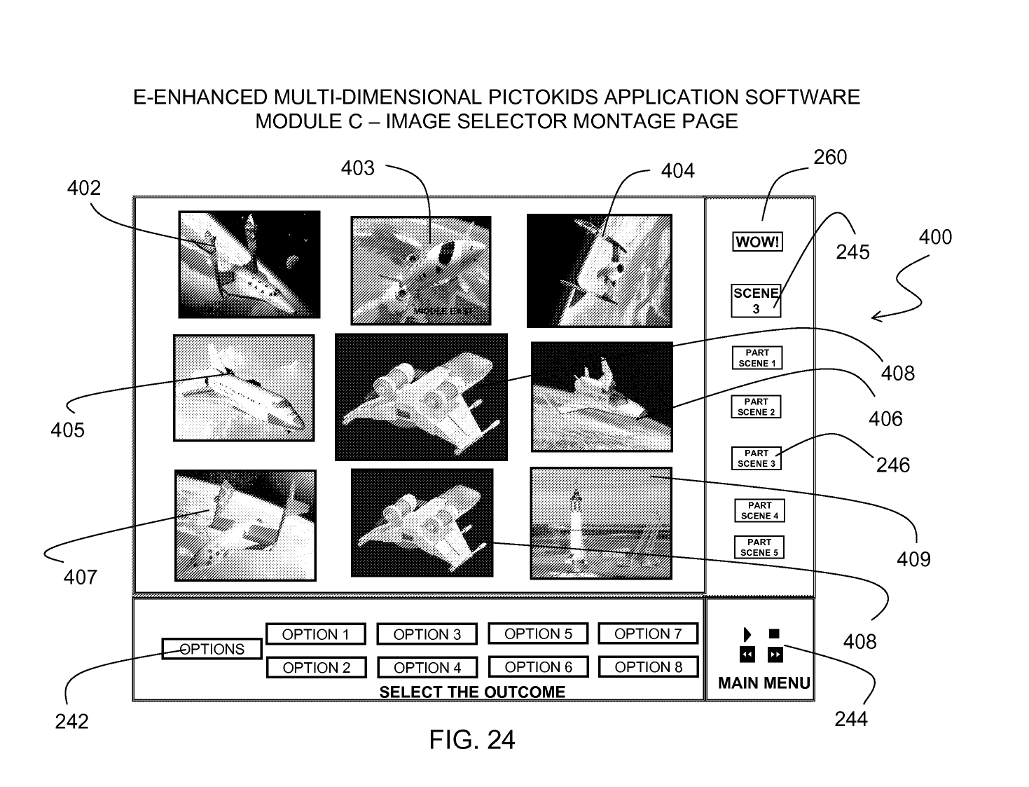

Based on these User selections an Image Selector Montage Page 380 is then presented that directs the User to select the outcome of the PictoKids Adventure as shown in FIG. 23. In this example, the User selects from images of Aliens 382-389 a hero to swoop down and save everyone at the World Cup Game. For a final scene of Wow!, the User selects a rocket ship from images of rocket ships 402-409 from the Image Selector Montage Pages 400 as shown in FIG. 24. The User's selections are secretly transformed into a series of PictoStorys 47 that show the Alien 386 deactivating the bomb 370 and defeating the criminal mastermind 296. For the final scene, the User 268 is shown in a spacesuit going for a ride on the friendly Alien's spaceship 406.

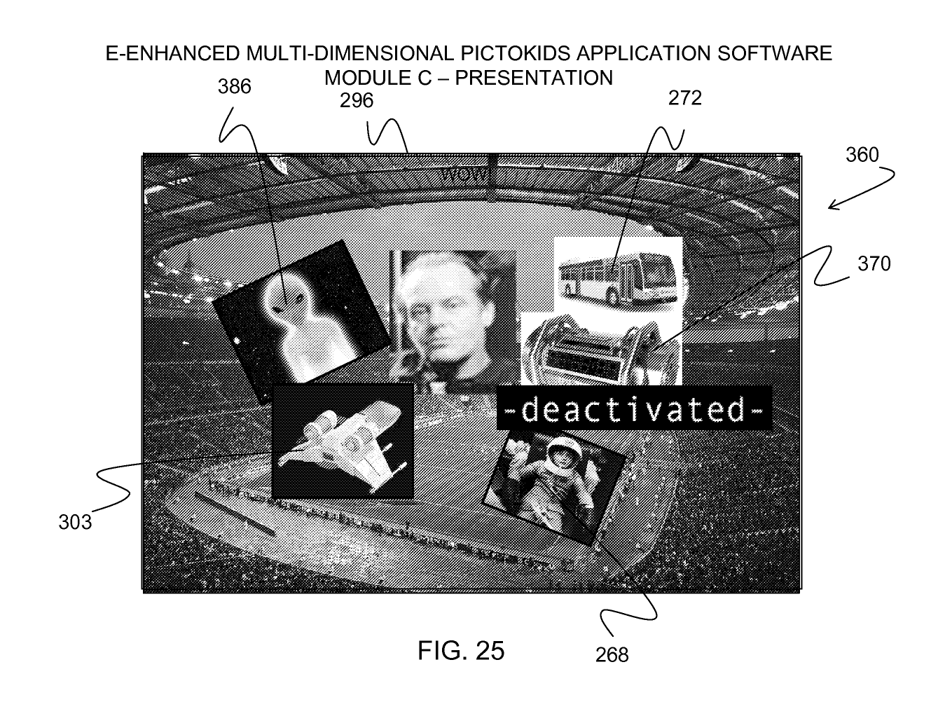

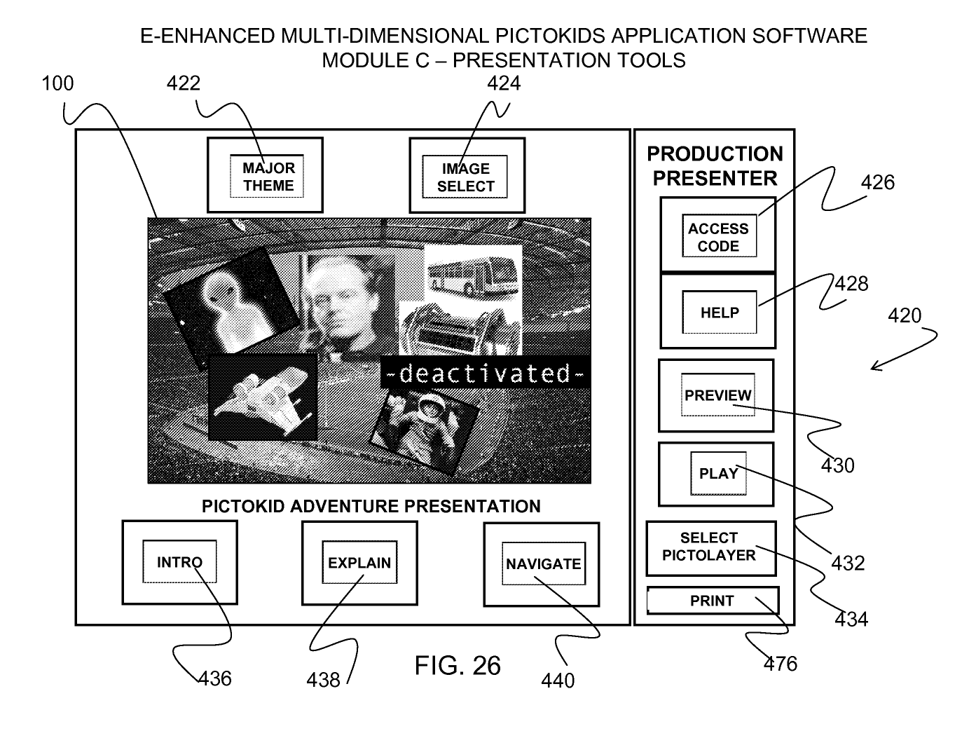

As shown in FIG. 25, the User's selections dynamically transform the chosen Theme into a PictoKids action-packed, Multi-Dimensional Show Not Tell PictoKids Adventure Presentation 360 using the PictoKids Application Software with the PictoGame and PictoStory Technologies. The Presentation intrigues, entices, entertains and uniquely pictorially presents the user selections. As shown in FIG. 26, the Production Presenter Display 420 provides control tools to the User to play and review the completed PictoKids Adventure Presentation 100. The Display 420 provides access to Major Theme Montage Pages 422 to create further presentations and Image Selector Montage Pages 424 to change selected images within the Presentation 100. An option 426 to enter an access or transfer code to increase PictoCash, time or points is also provided with a Help Option 428 to assist a User. A Preview Option 430 allows a User to view a partially completed or portions of a presentation. A Play Option Control 432 and Option Buttons to view the Instructional Presentations 28 are also provided. Also provided are options to select a PictoLayer 434 and to Print 476 a PictoLayer or the Presentation 100.

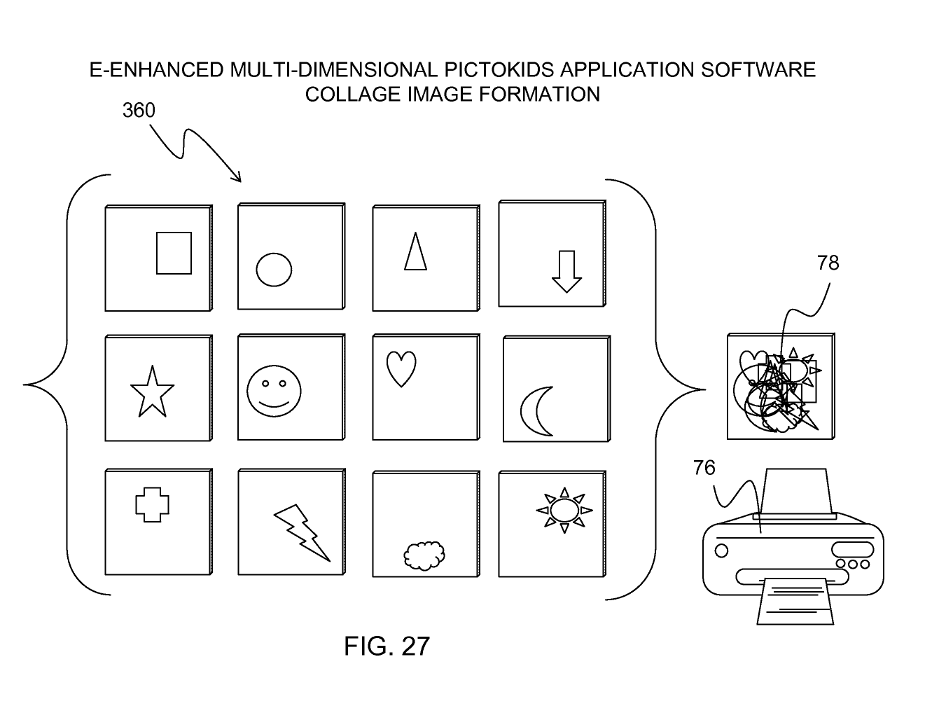

On completion of the Presentation 100, the User may add a message to the Epilogue 218, or a picture and signature of themselves in the credits and email the Presentation to a loved one. The Presentation 100 may also be submitted to a competition to obtain more PictoCash, or minutes, or points by comparing the Presentation with other uniquely created PictoKids Adventure Presentations 100. PictoLayers from the PictoKids Adventure Presentation 100 may further be printed on transparent sheets to form layered Collage Images 78 as shown in FIG. 27.

The invention has been described in detail with particular reference to certain preferred embodiments thereof, but it will be understood that variations and modifications can be effected within the spirit and scope of the invention. The claims should not be read as limited to the described order or elements unless stated to that effect. Therefore, all embodiments that come within the scope and spirit of the following claims and equivalents thereto are claimed as the invention.

What is claimed is:

1. A software system for the creation of a user designed enhanced multi-dimensional pictokids presentation, comprising:
application software installed on a computer system;
the application software comprising;
a blueprint generator;
a production populator;
a storyline generator;
a pictolayer generator;
a pictocomposite generator;
a pictostory generator;
an enhancements generator;
a production presenter; and
wherein the blueprint generator formats an architectural blueprint;
the production populator populates the architectural blueprint with a chosen theme and theme sub-topic;
the storyline generator structures a storyline having a plurality of scenes and part scenes based on the chosen theme and theme sub-topic;
the pictolayer generator stylizes a plurality of trans-snips from a plurality of images pictorially representing the plurality of scenes and part scenes;
the pictocomposite generator layers the plurality of trans-snips to form at least one composite image;
the pictostory generator creates at least one pictostory from at least one composite image representing one of at least a scene and part scene from the plurality of scenes and part scenes;
the enhancements generator associates at least one enhancement with one of at least one trans-snip from the plurality of trans-snips, at least one composite image, at least one pictostory and at least one scene or part scene from the plurality of scenes and part scenes within the architectural blueprint; and
the production presenter sequences at least one pictostory to create an enhanced multi-dimensional pictokids presentation.

2. The software system for the creation of a user designed enhanced multi-dimensional pictokids presentation of claim 1, wherein the themes and theme sub-topics are presented to a user using the pictooverlay interface.

3. The software system for the creation of a user designed enhanced multi-dimensional pictokids presentation of claim 1, wherein access to the software system requires the completion of a pictoidentity.

4. The software system for the creation of a user designed enhanced multi-dimensional pictokids presentation of claim 1, further comprising one of at least an introduction presentation, an explanation presentation and a navigation presentation.

5. The software system for the creation of a user designed enhanced multi-dimensional pictokids presentation of claim 1, wherein the themes and theme sub-topics are chosen from at least one of a type of character, a start from location, a destination, a time, a participant, a companion, a method of transportation, an event, an adversary, a reason, what happens, how it happens and the outcome of what happens.

6. The pictorial representation software system for the creation of a user designed enhanced multi-dimensional pictokids presentation of claim 5, wherein a plurality of images is presented to represent the themes and theme sub-topics.

7. The software system for the creation of a user designed enhanced multi-dimensional pictokids presentation of claim 1, wherein a trans-snip from the enhanced multi-dimensional pictokids presentation is printed on transparent sheets to form a collage image.

8. The software system for the creation of a user designed enhanced multi-dimensional pictokids presentation of claim 1, wherein a trans-snip from the enhanced multi-dimensional pictokids presentation is printed on pre-formed adhesive label cut outs.

9. The software system for the creation of a user designed enhanced multi-dimensional pictokids presentation of claim 1, wherein a trans-snip from the enhanced multi-dimensional pictokids presentation is printed on material adhered to a fabric fastener to be placed on a fabric fastener lined display board.

10. The software system for the creation of a user designed enhanced multi-dimensional pictokids presentation of claim 1, further comprising control tools to email the enhanced multi-dimensional pictokids presentation.

11. A method of transforming a theme choice by a user into a pictorial presentation, comprising the steps of:
accessing application software installed on a computer system;
displaying a plurality of images representing themes for a user to choose from;
accepting a user's choice for a theme;
displaying a plurality of images representing a series of theme sub-topics for a user to choose from;
accepting a user's choices for a series of theme sub-topics;
populating an architectural blueprint with the chosen theme and theme sub-topics;
structuring a storyline based on the chosen theme and theme sub-topics;
creating a plurality of pictolayers;
layering the plurality of pictolayers;
developing pictostorys from the plurality of layered pictolayers;
associating at least one enhancement with one of at least the pictolayers, layered pictolayers and pictostorys;
rendering at least the pictolayers, layered pictolayers, pictostorys and enhancements to create a pictorial presentation.

12. A method of transforming a theme choice by a user into a pictorial presentation of claim 11, further comprising the steps of:
structuring the storyline into scenes and part scenes;
applying a key concepts query to develop a textual outline of each scene and part scene.

13. A method of transforming a theme choice by a user into a pictorial presentation of claim 11, further comprising the step of accessing the application software using a pictoidentity.

14. A method of transforming a theme choice by a user into a pictorial presentation of claim 11, further comprising the step of presenting one of at least an introduction presentation, an explanation presentation and a navigation presentation to a user.

15. A method of transforming a theme choice by a user into a pictorial presentation of claim 11, further comprising the step of choosing themes and theme sub-topics from at least one of a type of character, a start from location, a destination, a time, a participant, a companion, a method of transportation, an event, an adversary, a reason, what happens, how it happens and the outcome of what happens.

16. A method of transforming a theme choice by a user into a pictorial presentation of claim 11, further comprising the step of printing at least one pictolayer on transparent sheets.

17. A method transforming a theme choice by a user into a pictorial presentation of claim 11, further comprising the steps of printing at least one pictolayer on pre-formed adhesive label cut outs.

18. A method of transforming a theme choice by a user into a pictorial presentation of claim 11, further comprising the step of printing at least one pictolayer on material adhered to a fabric fastener to be placed on a fabric fastener lined display board.

19. A method of transforming a theme choice by a user into a pictorial presentation of claim 11, further comprising the step of emailing the pictorial presentation.

20. A method of transforming a theme choice by a user into a pictorial presentation of claim 11, further comprising the step of restricting access to the application software system and pictorial presentation.
